(19) United States
(12) Patent Application Publication
(10) Pub. No.: US 2026/0029094 A1
(43) Pub. Date: Jan. 29, 2026

(54) PIPE MAPPING FOR FEATURE AND ASSET RECOGNITION USING ARTIFICIAL INTELLIGENCE

(71) Applicant: SeeScan, Inc., San Diego, CA (US)

(72) Inventors: Mark S. Olsson, La Jolla, CA (US); Michael J. Martin, San Diego, CA (US); Alexander L. Warren, Escondido, CA (US); Gina M. Hartman, San Diego, CA (US)

(21) Appl. No.: 19/274,389

(22) Filed: Jul. 18, 2025

Related U.S. Application Data
(60) Provisional application No. 63/674,749, filed on Jul. 23, 2024.

(51) Int. Cl. F17D 5/00

(52) U.S. Cl. CPC F17D 5/00

(57) ABSTRACT

Systems and methods are provided for recognizing and mapping features inside of pipes using Artificial Intelligence (AI). In an exemplary embodiment, a pipe inspection camera system including Inertial Navigation Systems (INS) and other sensor capabilities is inserted into a pipe to collect data that can be provided to a Deep Learning model to build a training set. Training data may include newly collected data and/or historical data. The model may be trained based on collected sets of training data, testing data, and/or user predefined classifiers. The Deep Learning model may use thresholds to determine if a set of data falls within a specific class. Classes may be based on data related to pipe features such as size, shape, material, age, routing or connection features including bends and/or joints, etc. AI data may be processed locally in the pipe inspection camera system, remotely on a mobile device, and/or in the Cloud.

### FIELD

This application claims priority under 35 U.S.C. § 119 (e) to U.S. Provisional Patent Application Ser. No. 63/674,749 entitled PIPE MAPPING FOR FEATURE RECOGNITION USING ARTIFICIAL INTELLIGENCE, filed Jul. 23, 2024, the content of which is incorporated by reference herein in its entirety for all purposes

This disclosure relates generally to systems and methods for recognizing and mapping features inside of pipes using Artificial Intelligence (AI). More specifically, but not exclusively, this disclosure relates to systems and methods for using image data and navigational sensor data collected from underground utility pipes, and classifying that data using a Deep Learning model.

### BACKGROUND

FIG. 1 illustrates a methods for collecting image data and sensor data inside a utility pipe or conduit, as known in the prior art. This data is then compared locally or remotely to store pipe technical specifications. For instance, there are many commercially available software packages available related to inspection data for utility mainlines. Some of these software packages include characteristic coding schemes for identifying pipe and utility characteristics, flaws, connections, routes, and other mainline inspection data. These software packages may include data bases of pipe and utility related data, or may be used to create such a database.

What is needed in the art is the ability to automate the process using Deep Learning by providing training data to a Neural Network, and using Artificial Intelligence (AI) to predict, with a very high probability level, specific characteristics of buried or hidden pipes or conduits. Accordingly, the present invention is directed towards addressing the above-described problems and other problems associated with collecting very large sets of data associated with buried objects, processing that data, and predicting with a high degree of probability the both general and specific information related to buried or hidden pipes or conduits.

### SUMMARY

This disclosure relates generally to systems and methods for determining and distinguishing characteristics of buried or hidden pipes or conduits using Artificial Intelligence (AI). More specifically, but not exclusively, this disclosure relates to systems and methods for collecting imaging and Inertial Navigation System (INS) sensor data (e.g. using one or more three axis gyroscopic sensors (typically MEMS), three axis accelerometers (typically MEMS), one or more three axis compass/magnetometers, and/or other inertial navigation sensors) in the camera head to generate inertial navigation data relative to the camera head. Once collected, the imaging and INS data, as well as data from other source, e.g. multifrequency electromagnetic data, voice annotation data, etc., may be combined with other data, for instance user predefined classifier data, or ground truth data (i.e. visually observable data), etc., and provided to a processor which outputs Training Data, i.e. data that can be used to train an algorithm or machine learning model to predict the outcome or probability that pipes and/or conduits possess specific characteristics and/or technical specifications. Neural Networks using AI rely on Training Data to learn and improve analysis and prediction accuracy. The training data is then provided to at least one Neural Network for processing using Artificial Intelligence (AI). By analyzing the training data, and recognizing patterns using Deep Learning, the Neural Network can classify the collected data based on a predicted probability. Classified data may then be displayed and presented to a user.

The ability to go out in the field and locate various underground objects or assets associated with utilities and communication systems, including pipes and conduits, store large amounts of data, and quickly and accurately analyze the data to determine buried or hi hidden pipe or conduit characteristics such as type, material, size, location, orientation, joints, bends and turns, flow and velocity, distance between joints, etc., would be greatly improved in the sense of quality of data, accuracy of data, and the speed of collecting and analyzing data using Artificial Intelligence processed on one or more Neural Networks.

In a pipe inspection camera push-in system there isn't really a good way to collect training data unless you a have a camera with navigational capabilities to account for the fact that the camera is turning and moving as it is pushed down a pipe, and combine this with a voice/audio recognition annotation system to recognize features undetectable by the camera. For instance, a user may use his voice by talking into a headset with voice recognition to identify, also known as tagging, an over-head vent, a pipe to the left or right, an area or location related to the camera, etc., to provide additional information related to the camera and its surroundings. In some embodiments, voice annotation may be machine converted to text. By combining data received from both a camera with navigational sensors along with data received from voice annotations, the limitations of each data collecting method can be overcome.

For instance, a camera equipped with navigational or other sensors may not know much about the environment outside the pipe or cavity into which it was inserted, and the collection of data using voice annotation may be limited by voice or other hands-free prompts which may be cumbersome. Combining the two types of data would provide much more detail which could stored, or displayed as raw data, or in the form of a three-dimensional (3D) map showing where the camera has been.

As an example, a camera with navigational sensors being moved through a pipe would know the pipe location, the direction the camera was traveling, when it was going straight, when it was going around a turn, and the degree of the bend of the turn, if it was going up an incline or down a decline, and the speed it was travelling. This information, combined with voice annotated data, would allow the creation of a database including various types of information such as pipe route, the size of the pipe, what pipe connecting fittings inside the pipe look like. Additionally, optical image recognition could be used with the camera for building a 3D map of where the camera has been. Navigational data could be obtained using various sensors such as a compass, an accelerometer, GPS and other satellite system sensors, etc.

Different types of training data can be used to create a training database which can be provided to AI for pattern recognition. Generally, at joints, i.e. wherever pipes are put together, a nice generally round, circular feature is created, and by moving a camera with sensors with respect to a circular feature, AI can be used to determine these features directly by pattern, without having to do direct image resolution. Also, once trained, AI can also be used to determine the distance between joints, the pipe material, the shape of the joints/fittings, and other specifics such as optimal velocity and flow through the pipes and pipe joints.

AI can be used to look directly at raw image data without having to do feature recognition to determine there is a circular or other shaped pipe features. AI can then combine this with direction and velocity data from INS system sensors to make specific pipe characteristic predictions, and/or build a training data base for such predications. Processing, understanding, and classifying enormous amounts of data requires the ability to learn and notice patterns. This task is too complex for humans to perform but perfectly suited for Artificial Intelligence (AI).

Using AI to look directly at raw imaged data without having to do feature recognition could allow, for instance, recognition of circular features or other shapes within a pipe. This data could be combined with the camera moving direction and velocity as determined by an inertial system, and used to predict pipe conditions and characteristics. This combined data could be used to create a detailed 3D map of underground pipes and other utilities.

A utility locator often referred to as a Geo-Locating Receiver (GLR), utility locator device or a locator, with a navigating camera head that uses INS systems, as well as other sensors, along with voice a annotating system for tagging objects, could be used to build a training data base for an AI system running on one or more Neural Networks.

In one aspect, a pipe inspection camera is pushed-into a pipe or conduit to collect imaging data. Imaging data may include still images and/or video images. The camera may include one or more Inertial Navigation System (INS) sensors such as three axis gyroscopic sensors (typically MEMS), three axis accelerometers (typically MEMS), three axis compass/magnetometers, and/or other inertial navigation sensors, accelerometers, GPS and other satellite system sensors, etc.

If used, a compass will need both hard and soft iron calibrations as a function of temperature to ensure accuracy. Collected imaging data and INS sensor data can then be used as training data, i.e. to assemble a training database. The training database can then used to train a machine learning Model machine. AI can then use the model on a Neural Network to make predictions, i.e. the probability that collected pipe data has specific characteristics and specifications.

Other forms of collected data may include, for example, multifrequency electromagnetic data, imaging data, mapping data which may include depth and orientation data, current and voltage data, even and odd harmonics, active and passive signals, spatial relationships to other lines and objects, fiber optic data, etc. Collected data may be single phase (10) or multiphase: for example, three phase (30), phase difference data, inductive data, data measured by applying a current, voltage, or similar property to an underground line and then measuring the resultant current or voltage at various points along that line or other lines. Collected data could also include Phase Difference Data. As an example, in the USA where the electrical power utility frequency is 60 Hz, the phase differences between narrow band 60 Hz harmonic signals could be extracted and used as Training Data.

Collected Data may be stored in local or remote memory, including the Cloud, and post-processed (as opposed to real-time processing), and then provided to a Neural Network as Training Data. Additionally, the Neural Network itself could process and analyze the Training Data in real-time, or post-process the data at a later time.

In one aspect, some or all of the collected underground data may be combined with additional data from other sources to form a “Data Suite.” Types of additional data are almost limitless and are well known in the art. For example, additional data may include data already known about underground assets such as type of equipment, orientation, connections, manufacturer, ownership, etc. Additional data may also include observational data observed below ground, for instance seen in an open pipe or trench, or above ground data, such as specific equipment, layout of equipment, manufacturer information placed on equipment, etc. Observed or measured above ground data is also almost limitless and well known in the art: for instance, utility boxes, power poles and lines, radio and cellular antennas, transformers, observable connections, line and pipe paths, conduits, etc.

Once collected, the Suite of Data by itself, or in combination with user defined underground asset classification or category data, is provided as Training Data, also known as a “Training Data Suite,” for Deep Learning to one or more Neural Networks. The Neural Networks are programmed to use Artificial Intelligence (AI) for determining with a high probability of accuracy specific information about the underground or hidden pipe or conduit.

In one aspect, AI is used with a pipe inspection camera, as well as one or more Inertial Navigation System (INS) sensors and/or other to understand and map features inside of pipes, as well as recognizing routes/paths the pipes are taking. Data obtained by AI can then be used to make a three-dimensional map of the pipes and/or conduits. Since AI is self-trained, i.e. it uses self-learning models that continually optimize the model by using newly available data, it can be used to accurately and efficiently recognize pipe routes, e.g. direction, angle, depth, starting and ending points, branches, connections to other systems pipes, etc.

As an example, if a pipe inspection camera goes through a 45 degree bend or turn, the AI system can recognize that it is a 45 degree pipe fitting vs a 90 degree pipe fitting, that it is an up-fitting or down fitting, and other characteristics, such as pipe types. For instance, it can be used to determine, i.e. make a high probability prediction, that the pipe is a plastic pipe, a cast iron pipe, a terracotta pipe, or some other type of pipe.

In one aspect, a user could collect AI training data using a pipe inspection camera with INS system or other navigation capabilities while also providing additional voice recognition data. For instance, a user wearing a headset with a microphone could audio annotate what they are observing in conjunction with what the camera is seeing and measuring. As an example, the user might notice and annotate a corner, a turn, some related signage, an over-head vent, pipe to the left, etc. There are of course an almost infinite number of examples that could be used.

Audio annotation may include audio to text conversion. So you can take the combined limitations of audio annotation with voice prompts or hands free prompts to enter commands with the headset, combined with one or more navigational sensor(s) that know the how the camera head is moving, e.g. turning, going straight, going up or down, etc., and all of this collected data can be used to build a database of what the pipe or conduit routes look like, what the pipe fittings look like, if the camera is being pushed to the side of a pipe, etc. This information combined with optical recognition allows a three dimensional (3D) map to be built of the pipe inspection. That is where the camera went, where it went straight, where it turned, etc. These types of details are aided with the use of a compass, accelerometers, and other sensor, inside the camera head.

In one aspect, the training data would be dynamically updated. Updates could be incremental, for instance at specific time intervals, or continuous. Also, training data sets could be different in different geographic locations. For instance, training data sets could be updated to take into account different electrical and other characteristics due to local, regional, or country differences, etc. As an example, AI predicted results could be compared to known results in order to test result accuracy. The term “predicted results” takes into account the fact that AI is making a probability or likelihood prediction that the data it has analyzed corresponds to a certain utility system, and to specific characteristics of the system.

In another aspect, Testing Data, and/or Quality Metrics could be provided to the Neural Network to get a confidence level of the accuracy of and results determined by AI.

In one aspect, information between an inertial navigation system (INS) and an imaging system is shared and/or combined, and provided to a Neural Network in order to train the network, and ultimately use Artificial Intelligence (AI) to analyze and make predictions from the sensor data. The combining or sharing of data between two or more sensors or sensor systems may be referred to as sensor fusion, and the data obtained may be referred to as fused data. One of ordinary skill in the art would understand that fused data, as defined here, is different than computer vision techniques such as, for example, Visual-Inertial Odometry (VIO) which fuses two separate odometry techniques, such as Visual Odometry (VO) and Inertial Odometry. Sensor data from the INS system and the imaging system may also be combined with data from other sensors for processing which may include traditional computing, and/or using a neural network (e.g. AI). Processing may be performed locally, remotely, and/or in the Cloud.

As an example, an imaging system with one or more camera or image sensors may be inserted into a hidden or buried underground utility pipe, conduit, or other void. As the camera is moving through the utility, e.g. a pipe, the images create a real-time or near real-time optical flow of what is being imaged. It is a model based system that is modeling what is encountered inside the pipe, e.g. direction, dimensions, pipe construction (e.g. welds, kinks, etc.), debris, fluids, defects, etc. This imaging data or optical flow can be combined or fused with INS data from on the camera, or on a push-cable that is attached to the camera, and/or other INS sensors that may be outside of the pipe, e.g. attached to a cable drum for storing and deploying the push-cable, or on a utility locator, etc. As an example, the INS system may include a 6 axis sensor, for instance a three axis accelerometer and a three axis gyroscope (gyro). Optionally, the INS system may include a 3-axis accelerometer, 3-axis gyroscope, and/or 3-axis magnetometer, i.e. in some embodiments a 9 axis sensor may be used to give additional data, e.g. compass heading data, and other well known INS system data. In other embodiments, only a gyroscope and an accelerometer may be used, e.g. for utility pipe diameter estimation. The fused data can then be provided to a traditional or neural network for processing including filtering, combining with other data, annotating, etc. The fused data may be used by itself or with other data, e.g. sensor data, ground truth data, etc. to train the neural network so that AI can make predictions about the data, Such AI predictions may include type of utility, e.g. gas, water, etc., ownership, manufacturer of the pipe, conduit, or void, etc., condition inside of the pipe, condition of the pipe itself including defects, welds, turns, kinks, bends, diameters, debris inside the pipe, etc.

In one aspect, results from the neural network are used as feedback to the sensors themselves to improve calibration. As an example, INS sensors can be calibrated or tuned to improve gravity vectors, i.e. improve the accuracy of the INS sensors or system by addressing the effects of gravity. In another example, sensors taking independent measurements may experience a displacement measurement by looking at how the optical data or stream line changes, how fast they move when camera has stopped moving, and then this data can be combined, processed and/or analyzed and result can be fed back to the sensors to improve the measured state variables. Accelerometer or other motion/movement sensors can use this same type of feedback to compensate for gyro biases, gyroscale factors, and other common states. As a result, mapping of the inside of the pipe will be improved by using INS sensors or other sensors that have been calibrated or fine tuned using the AI result. Global navigation logic that typically is used with sensor inputs can then be used along with, or replaced by sensor fusion using independent information that is being acquired from an optical feed.

In another aspect, a utility locator/GLR and a Sonde may be used along with the fused sensors, e.g. an INS system and a camera, may be used together, and the combined data can then be used with neural network to obtain an AI prediction of of pipe, conduit, or void characteristics. This may then compared to an existing map that was made with a similar method using a neural network using image recognition. The process may be iterative so that additional passes through the pipe may be compared to existing maps, the maps updating, and subsequent maps improve in accuracy. One of ordinary skill in the art would understand that AI predictions may incorporate many types of logic which are well known including but not limited to Bayesian networks or other probabilistic graphical models, Bayes networks, or other decision networks or logic. AI models may include but are not limited to Generative AI, Discriminative AI, Predictive AI, Conversational AI, machine learning, and other types of AI well known in the art . . .

In another aspect, a camera with an INS module attached to or adjacent to the camera is attached to a push-cable, and the camera is inserted via the push-cable into different sets of pipes. Data is collected using a calibration routine with a specific set of guidelines that is determined by a user. As an example, a calibration routine is configured by a user, or trained via a computing and/or neural network by teaching the calibration routine how far into a pipe the camera has traveled, i.e. the distance. For instance, the calibration routine may be trained to recognize that the camera has traveled one inch into a pipe, two inches into a pipe, three inches, etc., and then a map of the pipe(s) may be constructed showing details in the pipe that may have been previously unnoticed. Optical flow vectors, i.e. mapping or modeling of the images in two (2D) or three dimensions (3D) may be correlated with INS data to improve mapping or modeling accuracy. Accuracy may be improved by iterative mapping or modeling using collected camera and INS system data to train a neural network, and then use AI to make a prediction to update a map or model. Any AI predictions may than be used as feedback, i.e. as training data for the neural network. Accuracy would be improved by reducing errors in the imaging/camera data and the INS system by compensating for various known errors such as Inertial Measurement Unit (IMU) drift, temperature sensitivity errors, and/or optical flow scale errors by resulting data-driven bias compensation using AI in an iterative manner.

In one aspect, using a neural network to obtain a predictive AI result based on fused sensor data from an imaging sensor or camera along with an INS sensor or system, may be used for image novel view synthesis (NVS), i.e. to generate realistic images of inside the pipe from view points and/or angles not captured in the original fused sensor data.

In one aspect, processing of data may include using quaternions to represent three dimensional (3D) rotations. As an example, sensor fusion by include one or more gyroscopes, accelerometers, and/or magnetometers along with an imaging sensor or system, e.g. a camera or camera system. Processing may be performed with conventional computing techniques, and or using a neural network with predictive AI. Using quaternions along with fused data may reduce measurement errors such as gyro drift, i.e. the accumulation of error in a gyroscope's orientation estimate over time caused by bias, noise, or integration errors in the sensor data.

In one aspect, processing of fused data may incorporate motion vectors to adjust the INS system, or use the INS system to adjust the motion vectors. Either technique may be used to reduce INS sensor or system, and/or processing errors.

In this disclosure the terms “Deep Learning” and “Artificial intelligence (AI)” are used synonymously. However, there is actually a subtle difference. Deep Learning is an AI function that mimics the workings of the human brain in processing data for use in detecting objects, recognizing speech, translating languages, and making decisions. Deep Learning AI is able to learn without human supervision, drawing from data that is both unstructured and unlabeled (source: Investopedia.com). Deep Learning is a subset of machine learning where artificial Neural Networks, algorithms inspired by the human brain, learn from large amounts of data. Deep Learning allows machines to solve complex problems even when using a data set that is very diverse, unstructured and interconnected (source: Forbes.com). The task of analyzing and making sense of enormous amounts of collected data related to multifrequency electromagnetic data, as well as the addition of additional related data joined to form a Data Suite is too complex for humans to perform but perfectly suited for Artificial Intelligence (AI). In one aspect, AI, which is perfectly suited for pattern recognition, provides a user with classification and type probabilities for underground as well as above ground assets. Results may be provided to a user in numerous ways, including visually rendered on a display, audibly, tactilely, etc.

AI can use its training to output the probability of specific attributes being related to specific underground assets and the utilities the assets are related to. More specifically AI can determine the probability that certain things are related to other things, the nature between the different things, how far away the connections between the different things are, how far the connection between two things might be from where a current or previous measurement was taken based on the difference between the two things, and if some ground truth data was provided as part of the Training Data, very specific information like who owns or operates specific equipment, e.g. AT&T®, Verizon®, T-Mobile®, etc. AI can also be used to distinguish a specific communication standard used by a specific company, for instance 4G vs 5G cellular protocols, etc.

Some prior art systems exist that allow for frequency monitoring and the use of computers to calculate certain system parameters using various methods, for instance using Eigenvalues. However, these systems are very slow and do not allow the processing of large blocks of data in real or near real-time. Even if they could be programmed to accomplish such a task, systems such as these would take days, weeks, or even months to calculate any worthwhile parameters with even a reasonable accuracy. And with very large data sets, a final reliable solution may never be realized.

Current technology, for instance a cellphone, can be used while going down a street to map the position of things that can be seen. This does not really have much value because it is so limited. Deep Learning which uses AI can be used to map the relationship of things that cannot be seen, for instance underground or buried assets.

Various additional aspects, features, and functions are describe below in conjunction with the Drawings.

Details of example devices, systems, and methods that may be combined with the embodiments disclosed herein, as well as additional components, methods, and configurations that may be used in conjunction with the embodiments described herein, are disclosed in co-assigned patents and patent applications including: U.S. Pat. No. 7,009,399, issued Mar. 7, 2006, entitled OMNIDIRECTIONAL SONDE AND LINE LOCATOR; U.S. Pat. No. 7,136,765, issued Nov. 14, 2006, entitled A BURIED OBJECT LOCATING AND TRACING METHOD AND SYSTEM EMPLOYING PRINCIPAL COMPONENTS ANALYSIS FOR BLIND SIGNAL DETECTION; U.S. Pat. No. 7,221,136, issued May 22, 2007, entitled SONDES FOR LOCATING UNDERGROUND PIPES AND CONDUITS; U.S. Pat. No. 7,276,910, issued Oct. 2, 2007, entitled A COMPACT SELF-TUNED ELECTRICAL RESONATOR FOR BURIED OBJECT LOCATOR APPLICATIONS; U.S. Pat. No. 7,288,929, issued Oct. 30, 2007, entitled INDUCTIVE CLAMP FOR APPLYING SIGNAL TO BURIED UTILITIES; U.S. Pat. No. 7,298,126, issued Nov. 20, 2007, entitled SONDES FOR LOCATING UNDERGROUND PIPES AND CONDUITS; U.S. Pat. No. 7,332,901, issued Feb. 19, 2008, entitled LOCATOR WITH APPARENT DEPTH INDICATION; United States Patent 7,443, 154, issued Oct. 28, 2008, entitled MULTI-SENSOR MAPPING OMNIDIRECTIONAL SONDE AND LINE LOCATOR; U.S. Pat. No. 7,498,797, issued Mar. 3, 2009, entitled LOCATOR WITH CURRENT-MEASURING CAPABILITY; U.S. Pat. No. 7,498,816, issued Mar. 3, 2009, entitled OMNIDIRECTIONAL SONDE AND LINE LOCATOR; U.S. Pat. No. 7,336,078, issued Feb. 26, 2008, entitled MULTI-SENSOR MAPPING OMNIDIRECTIONAL SONDE AND LINE LOCATORS; U.S. Pat. No. 7,518,374, issued Apr. 14, 2009, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. No. 7,557,559, issued Jul. 7, 2009, entitled COMPACT LINE ILLUMINATOR FOR BURIED PIPES AND CABLES; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,733,077, issued Jun. 8, 2010, entitled MULTI-SENSOR MAPPING OMNIDIRECTIONAL SONDE AND LINE LOCATORS AND TRANSMITTER USED THEREWITH; U.S. Pat. No. 7,741,848, issued Jun. 22, 2010, entitled ADAPTIVE MULTICHANNEL LOCATOR SYSTEM FOR MULTIPLE PROXIMITY DETECTION; U.S. Pat. No. 7,755,360, issued Jul. 13, 2010, entitled PORTABLE LOCATOR SYSTEM WITH JAMMING REDUCTION; U.S. Pat. No. 7,825,647, issued Nov. 2, 2010, entitled METHOD FOR LOCATING BURIED PIPES AND CABLES; U.S. Pat. No. 7,830,149, issued Nov. 9, 2010, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. No. 7,864,980, issued Jan. 4,2011, entitled SONDES FOR LOCATING UNDERGROUND PIPES AND CONDUITS; U.S. Pat. No. 7,948,236, issued May 24, 2011, entitled ADAPTIVE MULTICHANNEL LOCATOR SYSTEM FOR MULTIPLE PROXIMITY DETECTION; U.S. Pat. No. 7,969,151, issued Jun. 28, 2011, entitled PRE-AMPLIFIER AND MIXER CIRCUITRY FOR A LOCATOR ANTENNA; U.S. Pat. No. 7,990,151, issued Aug. 2, 2011, entitled TRI-POD BURIED LOCATOR SYSTEM; U.S. Pat. No. 8,013,610, issued Sep. 6, 2011, entitled HIGH Q SELF-TUNING LOCATING TRANSMITTER; U.S. Pat. No. 8,035,390, issued Oct. 11, 2011, entitled OMNIDIRECTIONAL SONDE AND LINE LOCATOR; U.S. Pat. No. 8,106,660, issued Jan. 31, 2012, entitled SONDE ARRAY FOR USE WITH BURIED LINE LOCATOR; U.S. Pat. No. 8,203,343, issued Jun. 19, 2012, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 8,248,056, issued Aug. 21, 2012, entitled A BURIED OBJECT LOCATOR SYSTEM EMPLOYING AUTOMATED VIRTUAL DEPTH EVENT DETECTION AND SIGNALING; U.S. patent application Ser. No. 13/769,202, filed Feb. 15, 2013, entitled SMART PAINT STICK DEVICES AND METHODS; U.S. patent application Ser. No. 13/793,168, filed Mar. 11, 2013, entitled BURIED OBJECT LOCATORS WITH CONDUCTIVE ANTENNA BOBBINS; U.S. Pat. No. 8,400,154, issued Mar. 19, 2013, entitled LOCATOR ANTENNA WITH CONDUCTIVE BOBBIN; U.S. patent application Ser. No. 14/027,027, filed Sep. 13, 2013, entitled SONDE DEVICES INCLUDING A SECTIONAL FERRITE CORE STRUCTURE; U.S. patent application Ser. No. 14/033,349, filed Sep. 20, 2013, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. No. 8,547,428, issued Oct. 1, 2013, entitled PIPE MAPPING SYSTEM; U.S. Pat. No. 8,564,295, issued Oct. 22, 2013, entitled METHOD FOR SIMULTANEOUSLY DETERMINING A PLURALITY OF DIFFERENT LOCATIONS OF THE BURIED OBJECTS AND SIMULTANEOUDLY INDICATING THE DIFFERENT LOCATIONS TO A USER; U.S. patent application Ser. No. 14/148,649, filed Jan. 6, 2014, entitled MAPPING LOCATING SYSTEMS & METHODS; U.S. Pat. No. 8,635,043, issued Jan. 21, 2014, entitled LOCATOR AND TRANSMITTER CALIBRATION SYSTEM; U.S. Pat. No. 8,717,028, issued May 6, 2014, entitled SPRING CLIPS FOR USE WITH LOCATING TRANSMITTERS; U.S. Pat. No. 8,773,133, issued Jul. 8, 2014, entitled ADAPTIVE MULTICHANNEL LOCATOR SYSTEM FOR MULTIPLE PROXIMITY DETECTION; U.S. Pat. No. 8,841,912, issued Sep. 23, 2014, entitled PRE-AMPLIFIER AND MIXER CIRCUITRY FOR A LOCATOR ANTENNA; U.S. Pat. No. 9,041,794, issued May 26, 2015, entitled PIPE MAPPING SYSTEMS AND METHODS; U.S. Pat. No. 9,057,754, issued Jun. 16, 2015, entitled ECONOMICAL MAGNETIC LOCATOR APPARATUS AND METHOD; U.S. Pat. No. 9,081,109, issued Jul. 14, 2015, entitled GROUND-TRACKING DEVICES FOR USE WITH A MAPPING LOCATOR; U.S. Pat. No. 9,082,269, issued Jul. 14, 2015, entitled HAPTIC DIRECTIONAL FEEDBACK HANDLES FOR LOCATION DEVICES; U.S. Pat. No. 9,085,007, issued Jul. 21, 2015, entitled MARKING PAINT APPLICATOR FOR PORTABLE LOCATOR; U.S. Pat. No. 9,207,350, issued Dec. 8, 2015, entitled BURIED OBJECT LOCATOR APPARATUS WITH SAFETY LIGHTING ARRAY; U.S. Pat. No. 9,341,740, issued May 17, 2016, entitled OPTICAL GROUND TRACKING APPARATUS, SYSTEMS, AND METHODS; United States Patent 9,372, 117, issued Jun. 21, 2016, entitled OPTICAL GROUND TRACKING APPARATUS, SYSTEMS, AND METHODS; U.S. patent application Ser. No. 15/187,785, filed Jun. 21, 2016, entitled BURIED UTILITY LOCATOR GROUND TRACKING APPATUS, SYSTEMS, AND METHODS; U.S. Pat. No. 9,411,066, issued Aug. 9, 2016, entitled SONDES & METHODS FOR USE WITH BURIED LINE LOCATOR SYSTEMS; U.S. Pat. No. 9,411,067, issued Aug. 9, 2016, entitled GROUND-TRACKING SYSTEMS AND APPARATUS; United States U.S. Pat. No. 9,435,907, issued Sep. 6, 2016, entitled PHASE SYNCHRONIZED BURIED OBJECT LOCATOR APPARATUS, SYSTEMS, AND METHODS; U.S. Pat. No. 9,465,129, issued Oct. 11, 2016, entitled IMAGE-BASED MAPPING LOCATING SYSTEM; U.S. Pat. No. 9,488,747, issued Nov. 8, 2016, entitled GRADIENT ANTENNA COILS AND ARRAYS FOR USE IN LOCATING SYSTEM; U.S. Pat. No. 9,494,706, issued Nov. 15, 2016, entitled OMNI-INDUCER TRANSMITTING DEVICES AND METHODS; U.S. Pat. No. 9,523,788, issued Dec. 20, 2016, entitled MAGNETIC SENSING BURIED OBJECT LOCATOR INCLUDING A CAMERA; U.S. Pat. No. 9,571,326, issued Feb. 14, 2017, entitled METHOD AND APPARATUS FOR HIGH-SPEED DATA TRANSFER EMPLOYING SELF-SYNCHRONIZING QUADRATURE AMPLITUDE MODULATION (QAM); U.S. Pat. No. 9,599,449, issued Mar. 21, 2017, entitled SYSTEMS AND METHODS FOR LOCATING BURIED OR HIDDEN OBJECTS USING SHEET CURRENT FLOW MODELS; U.S. Pat. No. 9,599,740, issued Mar. 21, 2017, entitled USER INTERFACES FOR UTILITY LOCATORS; U.S. Pat. No. 9,625,602, issued Apr. 18, 2017, entitled SMART PERSONAL COMMUNICATION DEVICES AS USER INTERFACES; U.S. Pat. No. 9,632,202, issued Apr. 25, 2017, entitled ECONOMICAL MAGNETIC LOCATOR APPARATUS AND METHODS; U.S. Pat. No. 9,634,878, issued Apr. 25, 2017, entitled SYSTEMS AND METHODS FOR DATA TRANSFER USING SELF-SYNCHRONIZING QUADRATURE AMPLITUDE MODULATION (QAM); United States Patent Application, filed Apr. 25, 2017, entitled SYSTEMS AND METHODS FOR LOCATING AND/OR MAPPING BURIED UTILITIES USING VEHICLE-MOUNTED LOCATING DEVICES; U.S. Pat. No. 9,638,824, issued May 2, 2017, entitled QUAD-GRADIENT COILS FOR USE IN LOCATING SYSTEMS; United States Patent Application, filed May 9, 2017, entitled BORING INSPECTION SYSTEMS AND METHODS; U.S. Pat. No. 9,651,711, issued May 16, 2017, entitled HORIZONTAL BORING INSPECTION DEVICE AND METHODS; U.S. Pat. No. 9,684,090, issued Jun. 20, 2017, entitled NULLED-SIGNAL LOCATING DEVICES, SYSTEMS, AND METHODS; U.S. Pat. No. 9,696,447, issued Jul. 4, 2017, entitled BURIED OBJECT LOCATING METHODS AND APPARATUS USING MULTIPLE ELECTROMAGNETIC SIGNALS; U.S. Pat. No. 9,696,448, issued Jul. 4, 2017, entitled GROUND-TRACKING DEVICES AND METHODS FOR USE WITH A UTILITY LOCATOR; U.S. Pat. No. 9,703,002, issued Jun. 11, 2017, entitled UTILITY LOCATOR SYSTEMS & METHODS; U.S. patent application Ser. No. 15/670,845, filed Aug. 7, 2016, entitled HIGH FREQUENCY AC-POWERED DRAIN CLEANING AND INSPECTION APPARATUS & METHODS; U.S. patent application Ser. No. 15/681,250, filed Aug. 18, 2017, entitled ELECTRONIC MARKER DEVICES AND SYSTEMS; U.S. patent application Ser. No. 15/681,409, filed Aug. 20, 2017, entitled WIRELESS BURIED PIPE & CABLE LOCATING SYSTEMS; U.S. Pat. No. 9,746,572, issued Aug. 29, 2017, entitled ELECTRONIC MARKER DEVICES AND SYSTEMS; U.S. Pat. No. 9,746,573, issued Aug. 29, 2017, entitled WIRELESS BURIED PIPE AND CABLE LOCATING SYSTEMS; U.S. Pat. No. 9,784,837, issued Oct. 10, 2017, entitled OPTICAL GROUND TRACKING APPARATUS, SYSTEMS & METHODS; U.S. patent application Ser. No. 15/811,361, filed Nov. 13, 2017, entitled OPTICAL GROUND-TRACKING APPARATUS, SYSTEMS, AND METHODS; U.S. Pat. No. 9,841,503, issued Dec. 12, 2017, entitled OPTICAL GROUND-TRACKING APPARATUS, SYSTEMS, AND METHODS; U.S. patent application Ser. No. 15/846,102, filed Dec. 18, 2017, entitled SYSTEMS AND METHOD FOR ELECTRONICALLY MARKING, LOCATING AND VIRTUALLY DISPLAYING BURIED UTILITIES; U.S. patent application Ser. No. 15/866,360, filed Jan. 9, 2018, entitled TRACKED DISTANCE MEASURING DEVICES, SYSTEMS, AND METHODS; U.S. Pat. No. 9,891,337, issued Feb. 13, 2018, entitled UTILITY LOCATOR TRANSMITTER DEVICES, SYSTEMS, and METHODS WITH DOCKABLE APPARATUS; U.S. Pat. No. 9,914,157, issued Mar. 13, 2018, entitled METHODS AND APPARATUS FOR CLEARING OBSTRUCTIONS WITH A JETTER PUSH-CABLE APPARATUS; U.S. patent application Ser. No. 15/925,643, issued Mar. 19, 2018, entitled PHASE-SYNCHRONIZED BURIED OBJECT TRANSMITTER AND LOCATOR METHODS AND APPARATUS; U.S. patent application Ser. No. 15/925,671, issued Mar. 19, 2018, entitled MULTI-FREQUENCY LOCATING SYSTEMS AND METHODS; U.S. patent application Ser. No. 15/936,250, filed Mar. 26, 208, entitled GROUND TRACKING APPARATUS, SYSTEMS, AND METHODS; U.S. Pat. No. 9,927,545, issued Mar. 27, 2018, entitled MULTI-FREQUENCY LOCATING SYSTEMS & METHODS; U.S. Pat. No. 9,928,613, issued Mar. 27, 2018, entitled GROUND TRACKING APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 9,880,309, issued Mar. 28, 2018, entitled UTILITY LOCATOR TRANSMITTER APPARATUS & METHODS; U.S. patent application Ser. No. 15/954,486, filed Apr. 16, 2018, entitled UTILITY LOCATOR APPARATUS, SYSTEMS, AND METHODS; U.S. Pat. No. 9,945,976, issued Apr. 17, 2018, entitled UTILITY LOCATOR APPARATUS, SYSTEMS, AND METHODS; U.S. Pat. No. 9,989,662, issued Jun. 5, 2018, entitled BURIED OBJECT LOCATING DEVICE WITH A PLURALITY OF SPHERICAL SENSOR BALLS THAT INCLUDE A PLURALITY OF ORHTOGONAL ANTENNAE; U.S. patent application Ser. No. 16/036,713, issued Jul. 16, 2018, entitled UTILITY LOCATOR APPARATUS AND SYSTEMS; U.S. Pat. No. 10,024,994, issued Jul. 17, 2018, entitled WEARABLE MAGNETIC FIELD UTILITY LOCATOR SYSTEM WITH SOUND FIELD GENERATION; U.S. Pat. No. 10,031,253, issued Jul. 24, 2018, entitled GRADIENT ANTENNA COILS AND ARRAYS FOR USE IN LOCATING SYSTEMS; U.S. Pat. No. 10,042,072, issued Aug. 7, 2018, entitled OMNI-INDUCER TRANSMITTING DEVICES AND METHODS; U.S. Pat. No. 10,059,504, issued Aug. 28, 2018, entitled MARKING PAINT APPLICATOR FOR USE WITH PORTABLE UTILITY LOCATOR; U.S. patent application Ser. No. 16/049,699, filed Jul. 30, 2018, entitled OMNI-INDUCER TRANSMITTING DEVICES AND METHODS; U.S. Pat. No. 10,069,667, issued Sep. 4, 2018, entitled SYSTEMS AND METHODS FOR DATA TRANSFER USING SELF-SYNCHRONIZING QUADRATURE AMPLITUDE MODULATION (QAM); U.S. patent application Ser. No. 16/121,379, filed Sep. 4, 2018, entitled KEYED CURRENT SIGNAL UTILITY LOCATING SYSTEMS AND METHODS; U.S. patent application Ser. No. 16/125,768, filed Sep. 10, 2018, entitled BURIED OBJECT LOCATOR APPARATUS AND METHODS; U.S. Pat. No. 10,073,186, issued Sep. 11, 2018, entitled KEYED CURRENT SIGNAL UTILITY LOCATING SYSTEMS AND METHODS; U.S. patent application Ser. No. 16/133,642, issued Sep. 17, 2018, entitled MAGNETIC UTILITY LOCATOR DEVICES AND METHODS; U.S. Pat. No. 10,078,149, issued Sep. 18, 2018, entitled BURIED OBJECT LOCATORS WITH DODECAHEDRAL ANTENNA NODES; U.S. Pat. No. 10,082,591, issued Sep. 25, 2018, entitled MAGNETIC UTILITY LOCATOR DEVICES & METHODS; U.S. Pat. No. 10,082,599, issued Sep. 25, 2018, entitled MAGNETIC SENSING BURIED OBJECT LOCATOR INCLUDING A CAMERA; U.S. Pat. No. 10,090,498, issued Oct. 2, 2018, entitled MODULAR BATTERY PACK APPARATUS, SYSTEMS, AND METHODS INCLUDING VIRAL DATA AND/OR CODE TRANSFER; U.S. patent application Ser. No. 16/160,874, filed Oct. 15, 2018, entitled TRACKABLE DIPOLE DEVICES, METHODS, AND SYSTEMS FOR USE WITH MARKING PAINT STICKS; U.S. patent application Ser. No. 16/222,994, filed Dec. 17, 2018, entitled UTILITY LOCATORS WITH RETRACTABLE SUPPORT STRUCTURES AND APPLICATIONS THEREOF; U.S. Pat. No. 10,105,723, issued Oct. 23, 2018, entitled TRACKABLE DIPOLE DEVICES, METHODS, AND SYSTEMS FOR USE WITH MARKING PAINT STICKS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/241,864, filed Jan. 7, 2019, entitled TRACKED DISTANCE MEASURING DEVICES, SYSTEMS, AND METHODS; U.S. patent application Ser. No. 16/255,524, filed Jan. 23, 2019, entitled RECHARGEABLE BATTERY PACK ONBOARD CHARGE STATE INDICATION METHODS AND APPARATUS; U.S. Pat. No. 10,247,845, issued Apr. 2, 2019, entitled UTILITY LOCATOR TRANSMITTER APPARATUS AND METHODS; U.S. patent application Ser. No. 16/382,136, filed Apr. 11, 2019, entitled GEOGRAPHIC MAP UPDATING METHODS AND SYSTEMS; U.S. Pat. No. 10,274,632, issued Apr. 20, 2019, entitled UTILITY LOCATING SYSTEMS WITH MOBILE BASE STATION; U.S. patent application Ser. No. 16/390,967, filed Apr. 22, 2019, entitled UTILITY LOCATING SYSTEMS WITH MOBILE BASE STATION; U.S. patent application Ser. No. 29/692,937, filed May 29, 2019, entitled BURIED OBJECT LOCATOR; U.S. patent application Ser. No. 16/436,903, filed Jun. 10, 2019, entitled OPTICAL GROUND TRACKING APPARATUS, SYSTEMS, AND METHODS FOR USE WITH BURIED UTILITY LOCATORS; U.S. Pat. No. 10,317,559, issued Jun. 11, 2019, entitled GROUND-TRACKING DEVICES AND METHODS FOR USE WITH A UTILITY LOCATOR; U.S. patent application Ser. No. 16/449,187, filed Jun. 21, 2019, entitled ELECTROMAGNETIC MARKER DEVICES FOR BURIED OR HIDDEN USE; U.S. patent application Ser. No. 16/455,491, filed Jun. 27, 2019, entitled SELF-STANDING MULTI-LEG ATTACHMENT DEVICES FOR USE WITH UTILITY LOCATORS; U.S. Pat. No. 10,353,103, issued Jul. 16, 2019, entitled SELF-STANDING MULTI-LEG ATTACHMENT DEVICES FOR USE WITH UTILITY LOCATORS; U.S. patent application Ser. No. 16/551,653, filed Aug. 26, 2019, entitled BURIED UTILITY MARKER DEVICES, SYSTEMS, AND METHODS; U.S. Pat. No. 10,401,526, issued Sep. 3, 2019, entitled BURIED UTILITY MARKER DEVICES, SYSTEMS, AND METHODS; U.S. Pat. No. 10,324,188, issued Oct. 9, 2019, entitled OPTICAL GROUND TRACKING APPARATUS, SYSTEMS, AND METHODS FOR USE WITH BURIED UTILITY LOCATORS; U.S. patent application Ser. No. 16/446,456, filed Jun. 19, 2019, entitled DOCKABLE TRIPODAL CAMERA CONTROL UNIT; U.S. patent application Ser. No. 16/520,248, filed Jul. 23, 2019, entitled MODULAR BATTERY PACK APPARATUS, SYSTEMS, AND METHODS; U.S. Pat. No. 10,371,305, issued Aug. 6, 2019, entitled DOCKABLE TRIPODAL CAMERA CONTROL UNIT; U.S. Pat. No. 10,490,908, issued Nov. 26, 2019, entitled DUAL ANTENNA SYSTEMS WITH VARIABLE POLARIZATION; U.S. patent application Ser. No. 16/701,085, filed Dec. 2, 2019, entitled MAP GENERATION BASED ON UTILITY LINE POSITION AND ORIENTATION ESTIMATES; U.S. Pat. No. 10,534,105, issued Jan. 14, 2020, entitled UTILITY LOCATING TRANSMITTER APPARATUS AND METHODS; U.S. patent application Ser. No. 16/773,952, filed Jan. 27, 2020, entitled MAGNETIC FIELD CANCELING AUDIO DEVICES; U.S. patent application Ser. No. 16/780,813, filed Feb. 3, 2020, entitled RESILIENTLY DEFORMABLE MAGNETIC FIELD CORE APPARATUS AND APPLICATIONS; U.S. Pat. No. 10,555,086, issued Feb. 4, 2020, entitled MAGNETIC FIELD CANCELING AUDIO SPEAKERS FOR USE WITH BURIED UTILITY LOCATORS OR OTHER DEVICES; U.S. patent application Ser. No. 16/786,935, filed Feb. 10, 2020, entitled SYSTEMS AND METHODS FOR UNIQUELY IDENTIFYING BURIED UTILITIES IN A MULTI-UTILITY ENVIRONMENT; U.S. Pat. No. 10,557,824, issued Feb. 11, 2020, entitled RESILIENTLY DEFORMABLE MAGNETIC FIELD TRANSMITTER CORES FOR USE WITH UTILITY LOCATING DEVICES AND SYSTEMS; U.S. patent application Ser. No. 16/791,979, issued Feb. 14, 2020, entitled MARKING PAINT APPLICATOR APPARATUS; U.S. patent application Ser. No. 16/792,047, filed Feb. 14, 2020, entitled SATELLITE AND MAGNETIC FIELD SONDE APPARATUS AND METHODS; U.S. Pat. No. 10,564,309, issued Feb. 18, 2020, entitled SYSTEMS AND METHODS FOR UNIQUELY IDENTIFYING BURIED UTILITIES IN A MULTI-UTILITY ENVIRONMENT; U.S. Pat. No. 10,571,594, issued Feb. 25, 2020, entitled UTILITY LOCATOR DEVICES, SYSTEMS, AND METHODS WITH SATELLITE AND MAGNETIC FIELD SONDE ANTENNA SYSTEMS; U.S. Pat. No. 10,569,952, issued Feb. 25, 2020, entitled MARKING PAINT APPLICATOR FOR USE WITH PORTABLE UTILITY LOCATOR; U.S. patent application Ser. No. 16/810,788, filed Mar. 5, 2019, entitled MAGNETICALLY RETAINED DEVICE HANDLES; U.S. patent application Ser. No. 16/827,672, filed Mar. 23, 2020, entitled DUAL ANTENNA SYSTEMS WITH VARIABLE POLARIZATION; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,608,348, issued Mar. 31, 2020, entitled DUAL ANTENNA SYSTEMS WITH VARIABLE POLARIZATION; U.S. patent application Ser. No. 16/837,923, filed Apr. 1, 2020, entitled MODULAR BATTERY PACK APPARATUS, SYSTEMS, AND METHODS INCLUDING VIRAL DATA AND/OR CODE TRANSFER; U.S. patent application Ser. No. 17/235,507, filed Apr. 20, 2021, entitled UTILITY LOCATING DEVICES EMPLOYING MULTIPLE SPACED APART GNSS ANTENNAS; U.S. Provisional Patent Application 63/015,692, filed Apr. 27, 2020, entitled SPATIALLY AND PROCESSING-BASED DIVERSE REDUNDANCY FOR RTK POSITIONING; U.S. patent application Ser. No. 16/872,362, filed May 11, 2020, entitled BURIED LOCATOR SYSTEMS AND METHODS; U.S. patent application Ser. No. 16/882,719, filed May 25, 2020, entitled UTILITY LOCATING SYSTEMS, DEVICES, AND METHODS USING RADIO BROADCAST SIGNALS; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,677,820, issued Jun. 9, 2020, entitled BURIED LOCATOR SYSTEMS AND METHODS; U.S. patent application Ser. No. 16/902,245, filed Jun. 15, 2020, entitled LOCATING DEVICES, SYSTEMS, AND METHODS USING FREQUENCY SUITES FOR UTILITY DETECTION; U.S. patent application Ser. No. 16/902,249, filed Jun. 15, 2020, entitled USER INTERFACES FOR UTILITY LOCATORS; U.S. Pat. No. 10,690,795, issued Jun. 23, 2020, entitled LOCATING DEVICES, SYSTEMS, AND METHODS USING FREQUENCY SUITES FOR UTILITY DETECTION; U.S. patent application Ser. No. 16/908,625, filed Jun. 22, 2020, entitled ELECTROMAGNETIC MARKER DEVICES WITH SEPARATE RECEIVE AND TRANSMIT ANTENNA ELEMENTS; U.S. Pat. No. 10,690,796, issued Jun. 23, 2020, entitled USER INTERFACES FOR UTILITY LOCATORS; U.S. patent application Ser. No. 16/921,775, filed Jul. 6, 2020, entitled AUTO-TUNING CIRCUIT APPARATUS AND METHODS; U.S. Provisional Patent Application 63/055,278, filed Jul. 22, 2020, entitled VEHICLE-BASED UTILITY LOCATING USING PRINCIPAL COMPONENTS; U.S. patent application Ser. No. 16/995,801, filed Aug. 17, 2020, entitled UTILITY LOCATOR TRANSMITTER DEVICES, SYSTEMS, AND METHODS; U.S. patent application Ser. No. 17/001,200, filed Aug. 24, 2020, entitled MAGNETIC SENSING BURIED UTLITITY LOCATOR INCLUDING A CAMERA; U.S. Patent Ser. No. 16/995,793, filed Aug. 17, 2020, entitled UTILITY LOCATOR APPARATUS AND METHODS; U.S. Pat. No. 10,753,722, issued Aug. 25, 2020, entitled SYSTEMS AND METHODS FOR LOCATING BURIED OR HIDDEN OBJECTS USING SHEET CURRENT FLOW MODELS; U.S. Pat. No. 10,754,053, issued Aug. 25, 2020, entitled UTILITY LOCATOR TRANSMITTER DEVICES, SYSTEMS, AND METHODS WITH DOCKABLE APPARATUS; U.S. Pat. No. 10,761,233, issued Sep. 1, 2020, entitled SONDES AND METHODS FOR USE WITH BURIED LINE LOCATOR SYSTEMS; U.S. Pat. No. 10,761,239, issued Sep. 1, 2020, entitled MAGNETIC SENSING BURIED UTILITY LOCATOR INCLUDING A CAMERA; U.S. patent application Ser. No. 17/013,831, filed Sep. 7, 2020, entitled MULTIFUNCTION BURIED UTILITY LOCATING CLIPS; U.S. Pat. No. 10,777,919, issued Sep. 15, 2020, entitled MULTIFUNCTION BURIED UTILITY LOCATING CLIPS; U.S. patent application Ser. No. 17/020,487, filed Sep. 14, 2020, entitled ANTENNA SYSTEMS FOR CIRCULARLY POLARIZED RADIO SIGNALS; U.S. Patent Application Ser. No. 17/068,156, filed Oct. 12, 2020, entitled DUAL SENSED LOCATING SYSTEMS AND METHODS; United States Provisional Patent Application 63/091,67, filed Oct. 14, 2020, entitled ELECTRONIC MARKER-BASED NAVIGATION SYSTEMS AND METHODS FOR USE IN GNSS-DEPRIVED ENVIRONMENTS; U.S. Pat. No. 10,809,408, issued Oct. 20, 2020, entitled DUAL SENSED LOCATING SYSTEMS AND METHODS; U.S. Pat. No. 10,845,497, issued Nov. 24, 2020, entitled PHASE-SYNCHRONIZED BURIED OBJECT TRANSMITTER AND LOCATOR METHODS AND APPARATUS; U.S. Pat. No. 10,859,727, issued Dec. 8, 2020, entitled ELECTRONIC MARKER DEVICES AND SYSTEMS; U.S. Pat. No. 10,908,311, issued Feb. 2, 2021, entitled SELF-STANDING MULTI-LEG ATTACHMENT DEVICES FOR USE WITH UTILITY LOCATORS; U.S. Pat. No. 10,928,538, issued Feb. 23, 2021, entitled KEYED CURRENT SIGNAL LOCATING SYSTEMS AND METHODS; U.S. Pat. No. 10,935,686, issued Mar. 2, 2021, entitled UTILITY LOCATING SYSTEM WITH MOBILE BASE STATION; and U.S. Pat. No. 10,955,583, issued Mar. 23, 2021, entitled BORING INSPECTION SYSTEMS AND METHODS; U.S. Pat. No. 9,927,368, issued Mar. 27, 2021, entitled SELF-LEVELING INSPECTION SYSTEMS AND METHODS; U.S. Pat. No. 10,976,462, issued Apr. 13, 2021, entitled VIDEO INSPECTION SYSTEMS WITH PERSONAL COMMUNICATION DEVICE USER INTERFACES; U.S. Pat. No. 10,992,849, issued Apr. 27, 2021, entitled PIPE INSPECTION SYSTEMS WITH SELF-GROUNDING PORTABLE CAMERA CONTROLLERS; U.S. Pat. No. 11,016,381, issued May 25, 2021, entitled SPRING ASSEMBLIES WITH VARIABLE FLEXIBLE FOR USE WITH PUSH-CABLES AND PIPE INSPECTION SYSTEMS; U.S. patent application Ser. No. 17/397,940, filed Aug. 9, 2021, entitled INSPECTION SYSTEM PUSH-CABLE GUIDE APPARATUS; U.S. Pat. No. 11,088,890, issued Aug. 10, 2021, entitled VIDEO INSPECTION SYSTEMS AND METHODS USING SELF-SYNCHRONIZING QAM; U.S. Pat. No. 11,132,781, issued Sep. 28, 2021, entitled PIPE INSPECTION SYSTEM CAMERA HEADS; U.S. patent application Ser. No. 17/501,670, filed Oct. 14, 2021, entitled ELECTRONIC MARKER-BASED NAVIGATION SYSTEMS AND METHODS FOR USE IN GNSS-DEPRIVED ENVIRONMENTS; U.S. patent application Ser. No. 17/528,155, filed Nov. 16, 2021, entitled PORTABLE CAMERA CONTROLLER PLATFORM FPR USE WITH PIPE INSPECTION SYSTEMS; U.S. Pat. No. 11,178,317, issued Nov. 16, 2021, entitled HEAT EXTRACTION APPARATUS; U.S. patent application Ser. No. 17/528,956, filed Nov. 17, 2021, entitled VIDEO INSPECTION SYSTEM APPARATUS AND METHODS WITH RELAY MODULES AND CONNECTION PORTS; U.S. patent application Ser. No. 17/531,533, filed Nov. 19, 2021, entitled INPUT MULTIPLEXED SIGNAL PROCESSING APPARATUS AND METHODS; U.S. patent application Ser. No. 17/532,938, filed Nov. 22, 2021, entitled PIPE INSPECTION AND/OR MAPPING CAMERA HEADS, SYSTEMS, AND METHODS; U.S. Pat. No. 11,187,822, issued Nov. 30, 2021, entitled SONDE DEVICES INCLUDING SECTIONAL FERRITE CORE STRUCTURE; U.S. Pat. No. 11,187,971, issued Nov. 30, 2021, entitled ROTATING CONTACT ASSEMBLIES FOR SELF-LEVELING CAMERA HEADS; U.S. patent application Ser. No. 17/541,057, filed Dec. 2, 2021, entitled COLOR-INDEPENDENT MARKER DEVICE APPARATUS, METHODS, AND SYSTEMS; U.S. patent application Ser. No. 17/541,057, filed Dec. 2, 2021, entitled VIDEO INSPECTION SYSTEM, APPARATUS, AND METHODS WITH RELAY MODULES AND CONNECTION PORTCOLOR-INDEPENDENT MARKER DEVICE APPARATUS, METHODS, AND SYSTEMS; U.S. Pat. No. 11,193,767, issued Dec. 7, 2021, entitled SMART PAINT STICK DEVICES AND METHODS; U.S. Pat. No. 11,199,510, issued Dec. 14, 2021, entitled PIPE INSPECTION AND CLEANING APPARATUS AND SYSTEMS; U.S. Pat. No. 11,209,115, issued Dec. 28, 2021, entitled PIPE INSPECTION AND/OR MAPPING CAMERA HEADS, SYSTEMS, AND METHODS; U.S. Pat. No. 11,209,334, issued Dec. 28, 2021, entitled PORTABLE CAMERA CONTROLLER PLATFORM FOR USE WITH PIPE INSPECTION SYSTEMS; U.S. patent application Ser. No. 17/563,049, filed Dec. 28, 2021, entitled SONDE DEVICES WITH A SECTIONAL FERRITE CORE; U.S. Patent Application Ser. No. 17/687,538, filed Mar. 4, 2022, entitled ANTENNAS, MULTI-ANTENNA APPARATUS, AND ANTENNA HOUSINGS; U.S. Pat. No. 11,280,934, issued Mar. 22, 2022, entitled ELECTROMAGNETIC MARKER DEVICES FOR BURIED OR HIDDEN USE; U.S. Pat. No. 11,300,597, issued Apr. 12, 2022, entitled SYSTEMS AND METHODS FOR LOCATING AND/OR MAPPING BURIED UTILITIES USING VEHICLE-MOUNTED LOCATING DEVICES; U.S. Pat. No. 11,300,700, issued Apr. 12, 2022, entitled SYSTEM AND METHODS OF USING A SONDE DEVICE WITH A SECTIONAL FERRITE CORE STRUCTURE; U.S. patent application Ser. No. 17/845,290, filed Jun. 21, 2022, entitled DAYLIGHT VISIBLE AND MULTI-SPECTRAL LASER RANGEFINDERS AND ASSOCIATED SYSTEMS AND METHODS AND UTILITY LOCATOR DEVICES; U.S. patent application Ser. No. 17/868,709, filed Jul. 19, 2022, entitled INSPECTION CAMERA DEVICES AND METHODS; U.S. patent application Ser. No. 17/815,387, filed Jul. 27, 2022, entitled INWARD SLOPED DRUM FACE FOR PIPE INSPECTION CAMERA SYSTEM; U.S. Pat. No. 11,402,337, issued Aug. 2, 2022, entitled VIDEO PIPE INSPECTION SYSTEMS WITH VIDEO INTEGRATED WITH ADDITIONAL SENSOR DATA; U.S. Pat. No. 11,418,761, issued Aug. 16, 2022, entitled INSPECTION CAMERA DEVICES AND METHODS WITH SELECTIVELY ILLUMINATED MULTISENSOR IMAGING; U.S. Pat. No. 11,448,600, issued Sep. 20, 2022, entitled MULTI-CAMERA PIPE INSPECTION APPARATUS, SYSTEMS, AND METHODS; U.S. patent application Ser. No. 17/993,784, filed Nov. 23, 2022, entitled VIDEO PIPE INSPECTION SYSTEMS; U.S. Pat. No. 11,528,401, issued Dec. 13, 2022, entitled PIPE INSPECTION SYSTEMS WITH SELF-GROUNDING PORTABLE CAMERA CONTROLLERS; U.S. patent application Ser. No. 18/091,079, filed Dec. 29, 2022, entitled VIDEO INSPECTION SYSTEMS WITH WIRELESS ENABLED DRUM; U.S. patent application Ser. No. 18/148,850, filed Dec. 30, 2022, entitled SPRING ASSEMBLIES WITH VARIABLE FLEXIBILITY FOR USE WITH PUSH-CABLES AND PIPEINSPECTION SYSTEMS; U.S. Pat. No. 11,550,214, issued Jan. 10, 2023, entitled SPRING ASSEMBLIES WITH VARIABLE FLEXIBLE FOR USE WITH PUSH-CABLES AND PIPE INSPECTION SYSTEMS; U.S. Pat. No. 11,558,537, issued Jan. 17, 2023, entitled VIDEO INSPECTION SYSTEM WITH WIRELESS ENABLED CABLE STORAGE DRUM; MODULAR BATTERY SYSTEMS INCLUDING INTERCHANGEABLE BATTERY INTERFACE APPARATUS; U.S. patent application Ser. No. 18/162,663, filed Jan. 31, 2023, entitled UTILTY LOCATING SYSTEMS AND METHODS WITH FILTER TUNING FOR POWER GRID FLUCTUATIONS; U.S. patent application Ser. No. 18/121,547, filed Mar. 14, 2023, entitled DOCKABLE CAMERA REEL AND CAMERA CONTROL UNIT (CCU) SYSTEM; U.S. patent application Ser. No. 18/121,562, filed Mar. 14, 2023, entitled PIPE INSPECTION AND CLEANING APPARATUS AND SYSTEMS; U.S. Provisional Patent Application 63/492,473, filed Mar. 27, 2023, entitled VIDEO INSPECTION AND CAMERA HEAD TRACKING SYSTEMS AND METHODS; U.S. Pat. No. 11,614,412, issued Mar. 28, 2023, entitled PIPE INSPECTION SYSTEMS WITH JETTER PUSH-CABLE; U.S. Pat. No. 11,614,613, issued Mar. 28, 2023, entitled DOCKABLE CAMERA REEL AND CCU SYSTEM; U.S. patent application Ser. No. 18/130,341, filed Apr. 3, 2023, entitled VIDEO PUSH-CABLES FOR PIPE INSPECTION SYSTEMS; U.S. Pat. No. 11,621,099, issued Apr. 4, 2023, entitled COAXIAL VIDEO PUSH-CABLES FOR USE IN INSPECTION SYSTEMS; U.S. patent application Ser. No. 18/135,661, filed Apr. 17, 2023, entitled VIDEO PIPE INSPECTION SYSTEMS AND METHODS WITH SENSOR DATA; U.S. patent application Ser. No. 18/140,488, filed Apr. 27, 2023, entitled INTEGRATED FLEX-SHAFT CAMERA SYSTEM; U.S. Pat. No. 11,639,990, issued May 2, 2023, entitled VIDEO PIPE INSPECTION SYSTEMS WITH VIDEO INTEGRATED WITH ADDITIONAL SENSOR DATA; U.S. Pat. No. 11,649,917, issued May 16, 2023, entitled INTEGRATED FLEX-SHAFT CAMERA SYSTEM WITH HAND CONTROL; U.S. patent application Ser. No. 18/203,029, filed May 29, 2023, entitled SELF-LEVELING INSPECTION SYSTEMS AND METHODS; U.S. Pat. No. 11,665,321, issued May 30, 2023, entitled PIPE INSPECTION SYSTEM WITH REPLACEABLE CABLE STORAGE DRUM; U.S. patent application Ser. No. 18/207,898, filed Jun. 9, 2023, entitled SONDE DEVICES WITH A SECTIONAL CORE; U.S. Pat. No. 11,674,906, issued Jun. 13, 2023, entitled SELF-LEVELING INSPECTION SYSTEMS AND METHODS; U.S. Pat. No. 11,686,878, issued Jun. 27, 2023, entitled ELECTRONIC MARKER DEVICES FOR BURIED OR HIDDEN USE; U.S. Provisional Patent Application 63/514,090, filed Jul. 17, 2023, entitled SMARTPHONE MAPPING APPARATUS FOR ASET TAGGING AS USED WITH UTILITY LOCATOR DEVICES; U.S. Pat. No. 11,709,289, issued Jul. 25, 2023, entitled SONDE DEVICES WITH A SECTIONAL FERRITE CORE; U.S. patent application Ser. No. 18/365,225, filed Aug. 3, 2023, entitled SYSTEMS AND METHODS FOR INSPECTION ANIMATION; U.S. Pat. No. 11,719,376, issued Aug. 8, 2023, entitled DOCKABLE TRIPODAL CAMERA CONTROL UNIT; U.S. Pat. No. 11,719,846, issued Aug. 8, 2023, entitled BURIED UTILITY LOCATING SYSTEMS WITH WIRELESS DATA COMMUNICATION INCLUDING DETERMINATION OF CROSS COUPLING TO ADJACENT UTILITIES; U.S. patent application Ser. No. 18/233,285, filed Aug. 11, 2023, entitled BURIED OBJECT LOCATOR; U.S. patent application Ser. No. 18/236,786, filed Aug. 22, 2023, entitled MAGNETIC UTILITY LOCATOR DEVICES AND METHODS; U.S. Pat. No. 11,747,505, issued Sep. 5, 2023, entitled MAGNETIC UTILITY LOCATOR DEVICES AND METHODS; U.S. patent application Ser. No. 18/368,510, filed Sep. 14, 2023, entitled MULTIFUNCTION BURIED UTILITY LOCATING CLIPS; U.S. patent application Ser. No. 18/365,203, filed Sep. 14, 2023, entitled SYSTEMS AND METHODS FOR ELECTRONICALLY MARKING, LOCATING AND VIRTUALLY DISPLAYING BURIED UTILITIES; U.S. Pat. No. 11,768,308, issued Sep. 26, 2023, entitled SYSTEMS AND METHODS FOR ELECTRONICALLY MARKING, LOCATING AND VIRTUALLY DISPLAYING BURIED UTILITIES; U.S. Pat. No. 11,769,956, issued Sep. 26, 2023, entitled MULTIFUNCTION BURIED UTILITY LOCATING CLIPS; U.S. Pat. No. 11,782,179, issued Oct. 10, 2023, entitled BURIED OBJECT LOCATOR WITH DODECAHEDRAL ANTENNA CONFIGURATION APPARATUS AND METHODS; U.S. Pat. No. 11,789,093, issued Oct. 17, 2023, entitled THREE-AXIS MEASUREMENT MODULES AND SENSING METHODS; U.S. Provisional patent application Ser. No. 18/490,763, filed Oct. 20, 2023, entitled LINKED CABLE-HANDLING AND CABLE-STORAGE DRUM DEVICES AND SYSTEMS FOR COORDINATED MOVEMENT OF PUSH-CABLE; U.S. Pat. No. 11,796,707, issued Oct. 24, 2023, entitled USER INTERFACES FOR UTILITY LOCATORS; U.S. Provisional Patent Application 63/599,890, filed Nov. 16, 2023, entitled VIDEO INSPECTION AND CAMERA HEAD TRACKING SYSTEMS AND METHODS; U.S. patent application Ser. No. 18/528,773, filed Dec. 4, 2023, entitled PIPE INSPECTION SYSTEM CAMERA HEAD; U.S. Pat. No. 11,842,474, issued Dec. 12, 2023, entitled PIPE INSPECTION SYSTEM CAMERA HEADS; U.S. Patent Application Ser. No. 18/539,265, filed Dec. 14, 2023, entitled INTEGRAL DUAL CLEANER DRUM SYSTEMS AND METHODS; U.S. patent application Ser. No. 18/539,268, filed Dec. 14, 2023, entitled HIGH FREQUENCY AC-POWERED DRAIN CLEANING AND INSPECTION APPARATUS AND METHODS; U.S. patent application Ser. No. 18/544,042, filed Dec. 18, 2023, entitled SYSTEMS, APPARATUS, AND METHODS FOR DOCUMENTING UTILITY POTHOLES AND ASSOCIATED UTILITY LINES; U.S. Pat. No. 11,846,095, issued Dec. 19, 2023, entitled HIGH FREQUENCY AC-POWERED DRAIN CLEANING AND INSPECTION APPARATUS & METHODS; U.S. Pat. No. 11,859,755, issued Jan. 2, 2024, entitled INTEGRAL DUAL CLEANER CAMERA DRUM SYSTEMS AND METHODS; U.S. patent application Ser. No. 18/412,452, filed Jan. 12, 2024, entitled MULTI-CAMERA APPARATUS FOR WIDE ANGLE PIPE INTERNAL INSPECTION; U.S. Pat. No. 11,876,283, issued Jan. 16, 2024, entitled COMBINED SATELLITE NAVIGATION AND RADIO TRANSCEIVER ANTENNA DEVICES; U.S. patent application Ser. No. 18/414,785, filed Jan. 17, 2024, entitled SONDE DEVICES; U.S. Pat. No. 11,879,852, issued Jan. 23, 2024, entitled MULTI-CAMERA APPARATUS FOR WIDE ANGLE PIPE INTERNAL INSPECTION; U.S. Pat. No. 11,880,005, issued Jan. 23, 2024, entitled SONDE DEVICES INCLUDING A SECTIONAL FERRITE CORE STRUCTURE; U.S. Provisional Patent Application 63/625,259, filed Jan. 25, 2024, entitled ACCESSIBLE DRUM-REEL FRAME FOR PIPE INSPECTION CAMERA SYSTEM; U.S. Pat. No. 11,894,707, issued Feb. 6, 2024, entitled RECHARGEABLE BATTERY PACK ONBOARD CHARGE STATE INDICATION METHODS AND APPARATUS; U.S. Provisional Patent Application 63/552,522, filed Feb. 12, 2024, entitled ACCESSIBLE DRUM-REEL FRAME FOR PIPE INSPECTION CAMERA SYSTEM; U.S. Pat. No. 11,909,104, issued Feb. 20, 2024, entitled ANTENNAS, MULTI-ANTENNA APPARATUS, AND ANTENNA HOUSINGS; U.S. Pat. No. 11,909,150, issued Feb. 20, 2024, entitled ROBUST IMPEDANCE CONTROLLED SLIP RINGS; U.S. Provisional Patent Application 63/558,098, filed Feb. 26, 2024, entitled SYSTEMS, DEVICES, AND METHODS FOR DOCUMENTING GROUND ASSETS AND ASSOCIATED UTILITY LINES; U.S. Pat. No. 11,921,225, issued Mar. 5, 2024, entitled ANTENNA SYSTEMS FOR CIRCULARLY POLARIZED RADIO SIGNALS; U.S. patent application Ser. No. 18/611,449, filed Mar. 20, 2024, entitled VIDEO INSPECTION AND CAMERA HEAD TRACKING SYSTEMS AND METHODS; U.S. patent application Ser. No. 18/611,449, issued Mar. 20, 2024, entitled VIDEO INSPECTION AND CAMERA HEAD TRACKING SYSTEMS AND METHODS; U.S. Pat. No. 11,953,643, issued Apr. 9, 2024, entitled MAP GENERATION BASED ON UTILITY LINE POSITION AND ORIENTATION ESTIMATES; U.S. Pat. No. 11,962,943, issued Apr. 16, 2024, entitled INSPECTION CAMERA DEVICES AND METHODS; U.S. Provisional Patent 63/643,915, filed May 7, 2024, entitled SYSTEMS AND METHODS FOR LOCATING AND MAPPING BURIED UTILITY OBJECTS USING ARTIFICIAL INTELLIGENCE WITH LOCAL OR REMOTE PROCESSING; U.S. Pat. No. 11,988,951, issued May 21, 2024, entitled MULTI-DIELECTRIC COAXIAL PUSH-CABLES AND ASSOCIATED APPARATUS; U.S. Provisional Patent 63/659,722, filed Jun. 13, 2024, entitled VEHICLE-MOUNTING DEVICES AND METHODS FOR USE IN VEHICLE-BASED LOCATING SYSTEMS; U.S. Provisional application Ser. No. 18/747,912, filed Jun. 19, 2024, entitled INNER DRUM MODULE WITH PUSH-CABLE INTERFACE FOR PIPE INSPECTION; and U.S. Provisional application Ser. No. 18/758,937, filed Jun. 28, 2024, entitled FILTERING METHODS AND ASSOCIATED UTILITY LOCATOR DEVICES FOR LOCATING AND MAPPING BURIED UTILITY LINES; U.S. patent application Ser. No. 18/774,758, filed Jul. 16, 2024, entitled SMARTPHONE MOUNTING APPARATUS AND IMAGING METHODS FOR ASSET TAGGING AND UTILITY MAPPING AS USED WITH UTILITY LOCATING DEVICES; U.S. Provisional Patent 63/674,749, issued Jul. 23, 2024, entitled PIPE MAPPING FOR FEATURE AND ASSET RECOGNITION USING ARTIFICIAL INTELLIGENCE; U.S. Provisional Patent 63/692,642, issued Sep. 9, 2024, entitled ELECTRONIC MODULES AND ASSOCIATED SYSTEMS; United States Provisional Patent 63/694,102, issued Sep. 12, 2024, entitled METHODS AND APPARATUS FOR BATTERY SWAPPING IN UTILITY LOCATOR DEVICES AND OTHER COMPLEX BOOTABLE ELECTRONIC DEVICES; U.S. Provisional Patent 63/719,026, issued Nov. 11, 2024, entitled PUSH-CABLE WITH OFFSET JACKET EXTRUSION; U.S. Provisional Patent 63/726,858, issued Dec. 2, 2024, entitled DIGITAL SELF-LEVELING PIPE INSPECTION CAMERA SYSTEMS AND METHODS WITH AUTOMIC MAGNIFICATION; U.S. patent application Ser. No. 19/018,842, issued Jan. 13, 2025, entitled ACCESSIBLE DRUM-REEL FRAME FOR PIPE INSPECTION CAMERA SYSTEM; U.S. Provisional Patent Application 63/761,029, filed Feb. 20, 2025, entitled UTILITY LOCATING SYSTEMS, DEVICES, AND METHODS EMPLOYING SPATIAL AUDIO; U.S. patent application Ser. No. 19/059,288, filed Feb. 21, 2025, entitled SYSTEMS, DEVICES, AND METHODS FOR DOCUMENTING GROUND ASSETS AND ASSOCIATED UTILITY LINES; U.S. Provisional Patent Application 63/770,287, filed Mar. 11, 2025, entitled WORLD FRAME/LOCAL FRAME MAPPING AND RE-MAPPING IN A UTILITY LOCATION SYSTEM; U.S. Pat. No. 12,253,382, issued Mar. 18, 2025, entitled VEHICLE-BASED UTILITY LOCATING USING PRINCIPAL COMPONENTS; U.S. patent application Ser. No. 18/198,495, filed May 18, 2025, entitled SYSTEMS AND METHODS FOR LOCATING AND MAPPING BURIED UTILITY OBJECTS USING ARTIFICIAL INTELLIGENCE WITH LOCAL OR REMOTE PROCESSING; and U.S. patent application Ser. No. 19/234,473, filed Jun. 11, 2025, entitled VEHICLE-MOUNTING DEVICES AND METHODS FOR USE IN VEHICLE-BASED LOCATING SYSTEMS. The content of each of the above-described patents and applications is incorporated by reference herein in its entirety. The above applications may be collectively denoted herein as the “co-assigned applications” or “incorporated applications.”

### BRIEF DESCRIPTION OF THE DRAWINGS

FIG. 1 is an illustration of a method to collect image sensor data, and compare it to a database associated with pipes and/or conduits, as known in the prior art.

FIG. 2 is an illustration of an embodiment of a method of using Deep Learning/artificial intelligence to recognize patterns and make predictions related to characteristics of underground or buried pipes or conduits.

FIG. 3 is an illustration of an embodiment of a system, including a service worker using a portable locator with Inertial Navigation System (INS) sensors, as well as a push-in type pipe inspection camera to collect data related to underground or buried pipes or conduits, in accordance with certain aspects of the present invention.

FIG. 4 is an illustration of an embodiment of a system, including a vehicle equipped with a locator to collect electromagnetic frequency data or other data from underground or buried assets, in accordance with certain aspects of the present invention.

FIG. 5 is an illustration of an embodiment of a method of providing training data to a Neural Network to use Deep Learning/artificial intelligence to recognize patterns and make predictions related to underground utilities, in accordance with certain aspects of the present invention.

FIG. 6 is an illustration of an embodiment of a method of using Artificial Intelligence (AI) to classify collected data based on a predicted probability, and to test the accuracy of the prediction, as known in the prior art.

FIG. 7 is an illustration of an embodiment of a data base structure for using Artificial Intelligence (AI) to recognize patterns, in accordance with certain aspects of the present invention.

FIG. 8 is an illustration of an embodiment of a chart showing various types of collected and other data as training data for Deep Learning in a Neural Network that uses Artificial Intelligence (AI), in accordance with certain aspects of the present invention.

FIG. 9 is an illustration of an embodiment of a method using Fused Sensor Data as training data for Deep Learning in a Neural Network that uses Artificial Intelligence (AI), in accordance with certain aspects of the present invention.

### DETAILED DESCRIPTION

It is noted that as used herein, the term “exemplary” means “serving as an example, instance, or illustration.” Any aspect, detail, function, implementation, and/or embodiment described herein as “exemplary” is not necessarily to be construed as preferred or advantageous over other aspects and/or embodiments.

### Example Embodiments

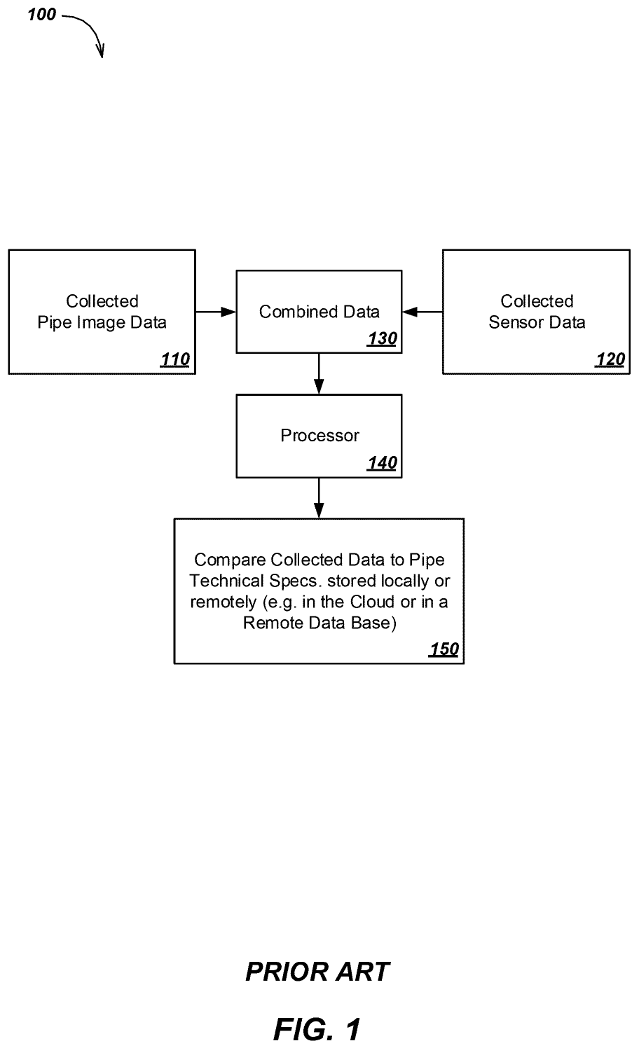

FIG. 1 illustrates details of an exemplary embodiment of a method to collect image sensor data, and compare it to a database associated with pipes and/or conduits. Method 100 may include collecting pipe image data block 110 and collecting sensor data from inside a pipe or conduit, combining the data block 130, and then processing the combined data block 140. In block 150 the collected data is compared to pipe technical specifications. The technical specifications may be stored locally, or remotely, e.g. in the cloud or a remote data base.

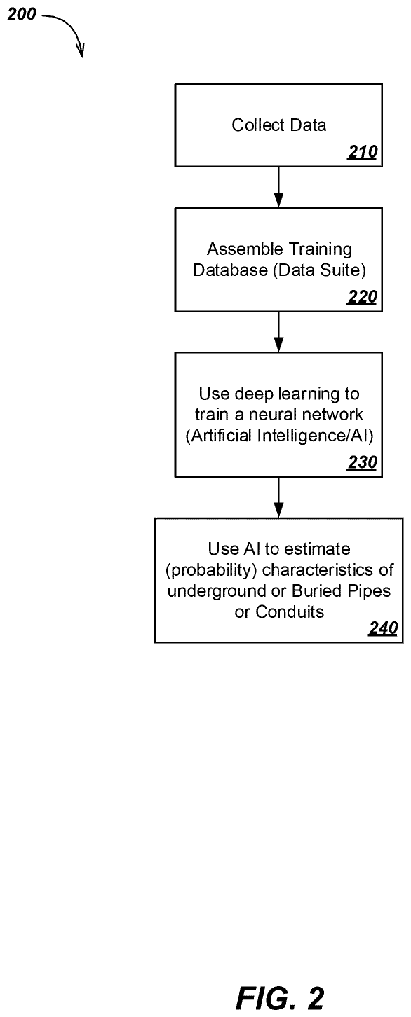

FIG. 2 illustrates details of an exemplary method 200 of using Deep Learning/artificial intelligence to recognize patterns and make predictions related to underground utilities. The method starts at block 210 collecting data and proceeds to block 220 where a Training Data Base, also known as a Data Suite or Training Data Suite, is assembled. The method then proceeds to block 230 where Deep Learning is used to train a Neural Network using Artificial Intelligence. Finally, the method proceeds to block 240 where AI estimates the probability characteristics of underground or Buried Pipes or Conduits including but not limited to pipe type, pipe material, pipe size, pipe shape, pipe routing features, pipe connections, and pipe fitting characteristics

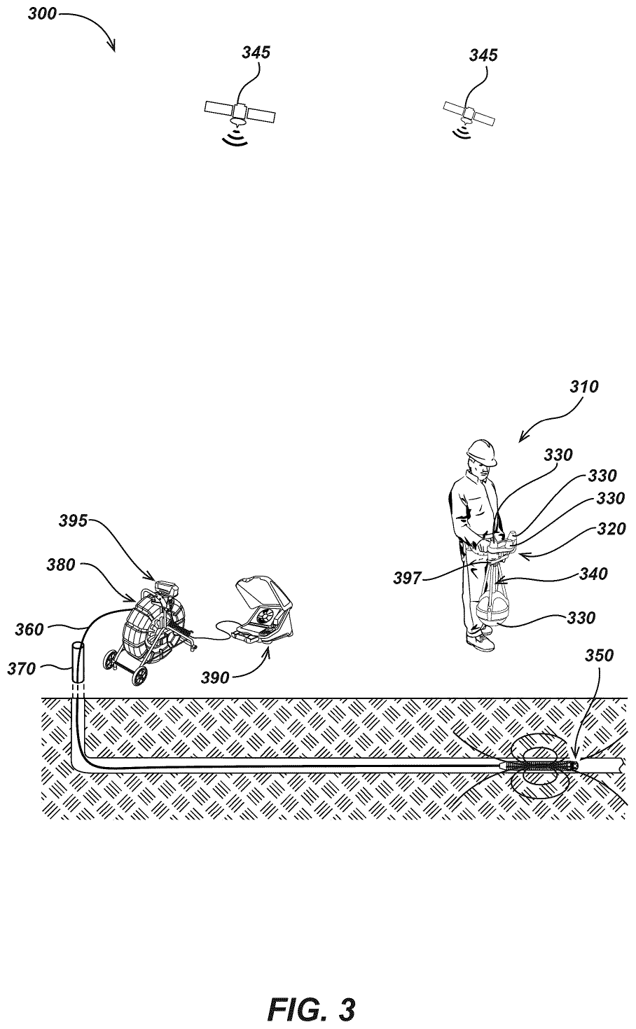

FIG. 3 illustrates details of an exemplary embodiment 300 of a system including a service worker 310 using a portable locator 320 which may include one or more antennas 330 for measuring EMF or other signals. Other types of antennas such as GNSS (Global Navigation Satellite System) and/or GPS antennas may also be included. One or more antennas 330, e.g. GPS, GNSS, or other satellite antennas may be configured to communicate with one or more satellites 345.

A Pipe-inspection camera 350 for collecting internal pipe and/or conduit imaging data may be provided. One or more more Inertial Navigation System (INS) sensors 340 may be integrated in camera 350. Optionally, one or more INS sensors 340 may be integrated with locator 320. Other types of sensors such as environmental sensors, movement sensors, sound sensors, and other sensors known in the art may also be included (not shown) may be located in camera 350, and/or locator 320.

Pipe-inspection camera 350 may be attached to the distal end of a push-cable 360 which is deployed and/or stored on cable-reel 380. A CCU 390 (camera control unit) for communicating with, and controlling camera 350 may be provided. Cable-reel 380 may include a wireless communication module 395, and locator 320 may also include a wireless communication module 397. Wireless communication modules 395 and 397 may be configured to communicate with each other, or with other mobile electronic devices (not shown) such as mobile phones, laptops, iPads, etc., or directly to a Cloud network (not shown). Camera 350 may have a camera head (typically the front portion of the camera 350) which may contain INS sensors or other sensors 340. Data from sensors 340 may be transmitted over push-cable 360 to CCU 390 or wireless module 395 attached to cable-reel 380, and then may be optionally transmitted to the locator 320 either via hardwire, or wirelessly to module 397. AI processing can be done at cable-reel 380, or data may be sent to a phone, tablet, etc. and/or to the Cloud for AI or other processing.

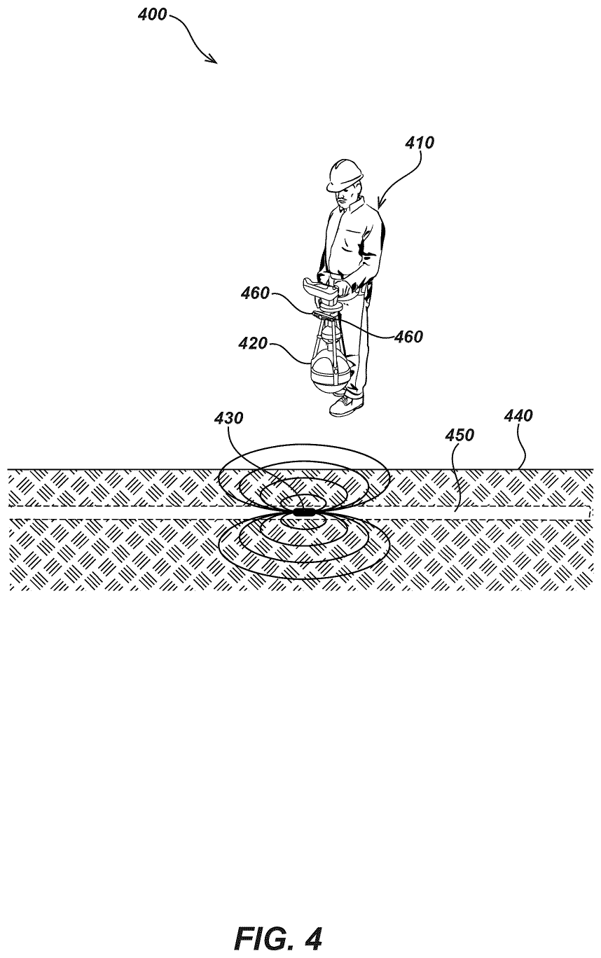

FIG. 4 illustrates details of an exemplary embodiment 400 of a system including a service worker 410 using a portable locator 420, and a Sonde 430 located underground 440 to collect single or multifrequency electromagnetic data from an buried or underground pipe or conduit 450. In some embodiments, system 400 may include one or more cameras 460 which could be attached to, or integral with portable locator 420, or could be located separately. Cameras 460 may be used to collect image data that can be used as AI training data for identifying above ground features such as road signs, utility equipment or signs, environmental features, and the like.

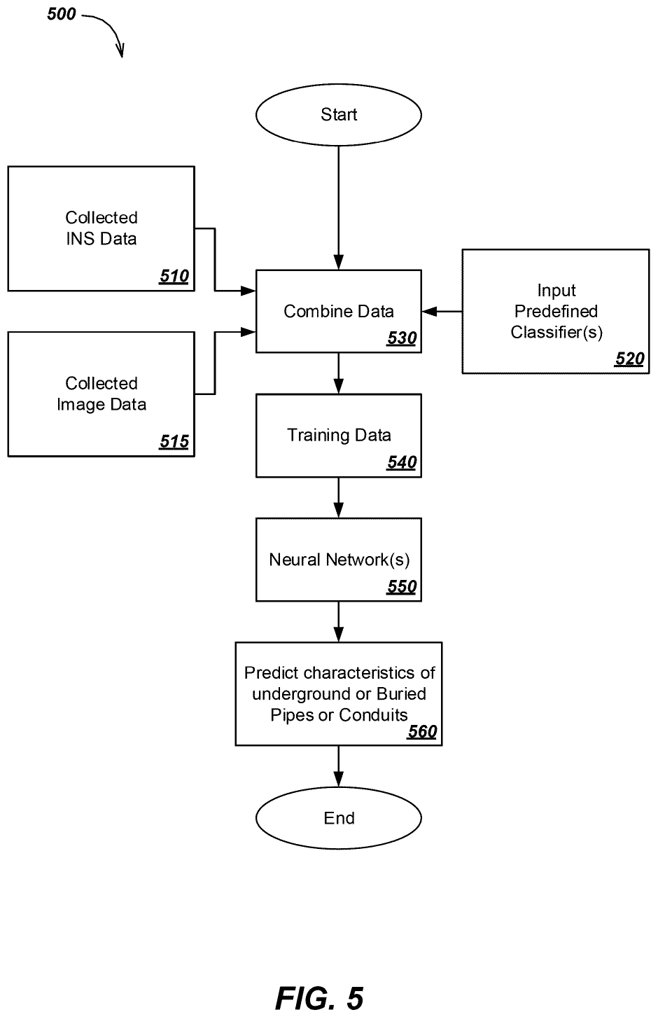

FIG. 5 illustrates details of an exemplary embodiment 500 of a method of providing training data to a Neural Network to use Deep Learning/artificial intelligence to recognize patterns and make predictions related to underground utilities. Collected INS (Inertial Data System) Data 510, Collected Image Data 510, and any Predefined Classifier(s) 520 which may be inputted or entered by a user, are combined in block 530. Other data such as image data, harmonics data, etc. may also be combined in block 530. The Combined data is also known as a Data Suite. Data combined at 530 becomes available to be used as Training Data, also known as a Training Data Suite, at block 540. The Training Data 540 is then provided to one or more Neural Networks 550 which use Deep Learning to predict characteristics of underground or buried pipes or conduits. 560. Artificial Intelligence (AI) is used to provide a probability that pipes and/or conduits have specific characteristics, have relationships between other pipes and/or conduits, and fall into one or more classification or categories by using the training data to recognize patterns.

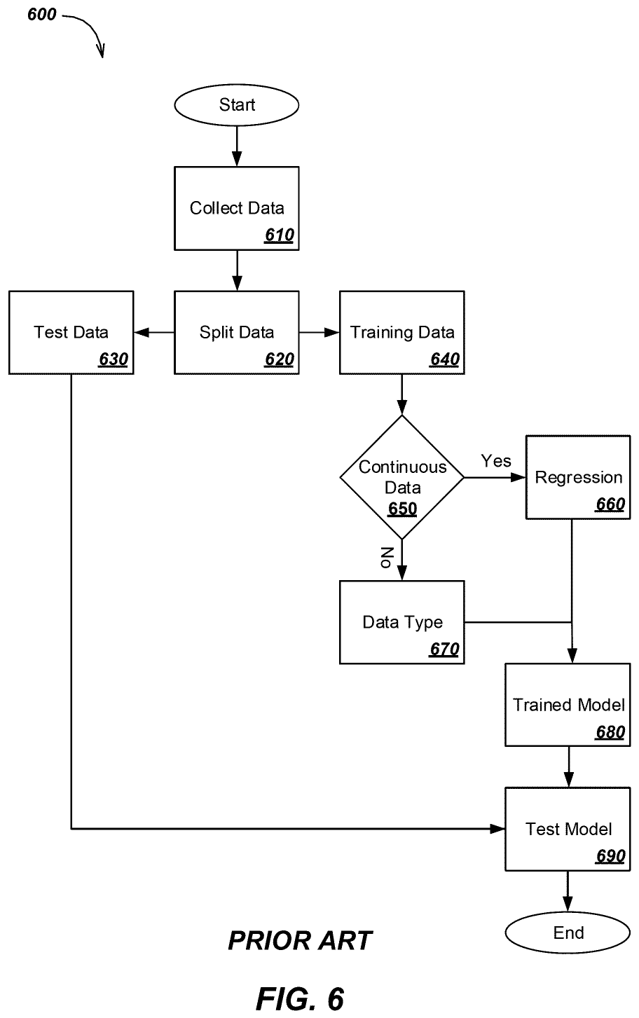

FIG. 6 illustrates details of an exemplary embodiment 600 of a method of providing test data to a Deep Learning system that uses Artificial Intelligence (AI) to check the accuracy of determined predictions, as known in the prior art. The method starts by Collecting Data 610. This step is followed by Splitting the Data 620 into Test Data 630 and Training Data 640. In decision block 650 it is determined whether the Training Data 640 is continuous (YES), or non-continuous (NO). If the answer is YES, the method proceeds to block 660 for Regression Testing; if the answer is NO, the method proceeds to block 670 to determine a Data Type (e.g. electromagnetic data, video data, user inputted classifications or categories, etc.). In block 680 the Trained Model is determined using AI based on the training data provided, and in block 690 the accuracy of the Trained Model is tested using the Test Data 630.

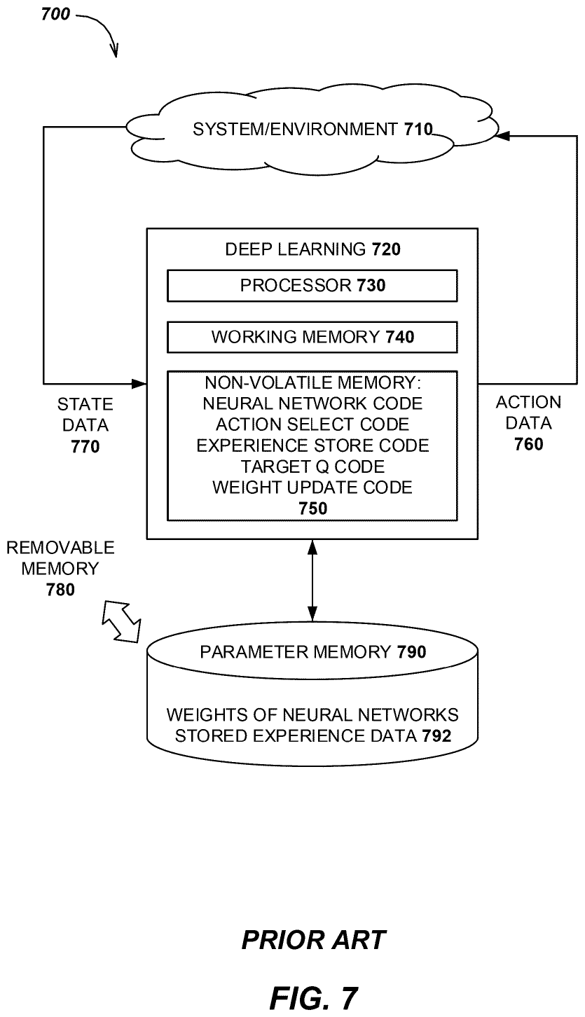

FIG. 7 illustrates details of an exemplary embodiment 700 of a database structure for using Artificial Intelligence (AI) to recognize patterns, as known in the prior art. The database structure includes a System/Environment 710, Deep Learning 720 which includes a Processor 730, Working Memory 740, and Non-Volatile Memory 750. Action Data 760 is provided to the System/Environment 710 which outputs State Data 770. Removable Memory 780 is provided, as well as a Parameter Memory 790. Weights of one or more Neural Networks 792 are provided to Deep Learning 720.

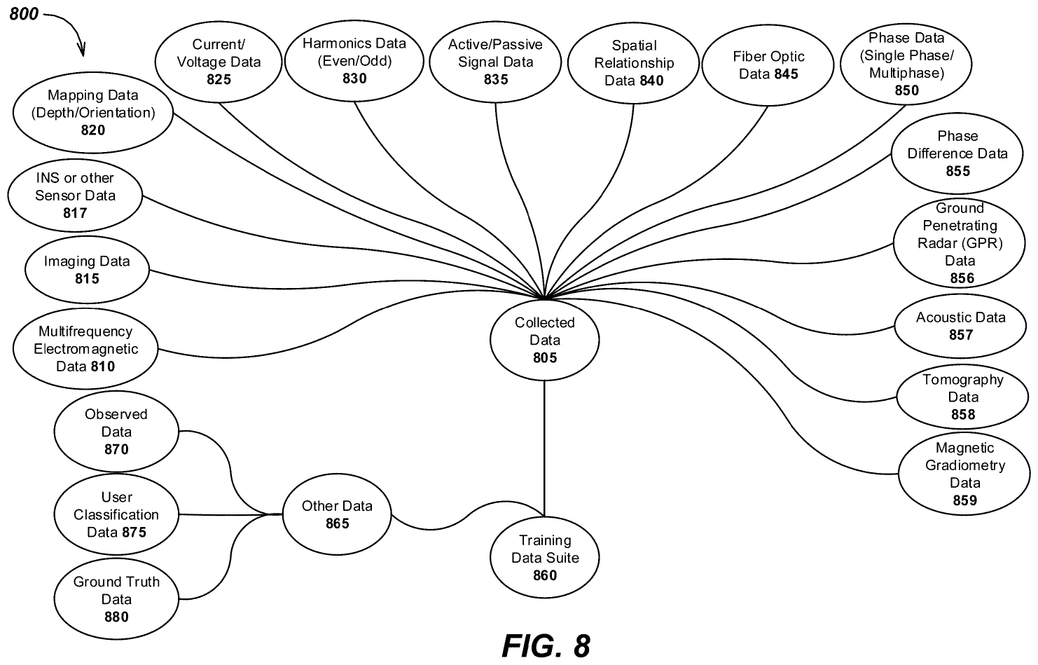

FIG. 8 illustrates details of an exemplary embodiment 800 of a chart showing various types of collected and other data as training data for Deep Learning in a Neural Network that uses Artificial Intelligence (AI). Collected data 805 may include Multifrequency Electromagnetic Data 810, Imaging Data 815, INS or other sensor data 817, Mapping Data 820 which may include Depth and/or Orientation Data, Current and/or Voltage Data 825, Harmonics Data 830 including Even and/or Odd Harmonics Data, Active and/or Passive Signal Data 835, Spatial Relationship Data 840, Fiber Optic Data 845, Phase Data 850 which may include Single Phase or Multiphase Data, and Phase Difference Data 855. It is contemplated that additional types of Collected Data 805 related to utilities and communication systems could also be used, and would be apparent to those skilled in the art. Training Suite Data 860, which may include Collected Data 805, may also include Other Data 865. Other Data 865 may include one or more of the following: Observed Data 870, User Classification Data 875, and Ground Truth Data 880. It is contemplated that additional types of Other Data 865 related to utilities and communication systems could also be used, and would be apparent to those skilled in the art.

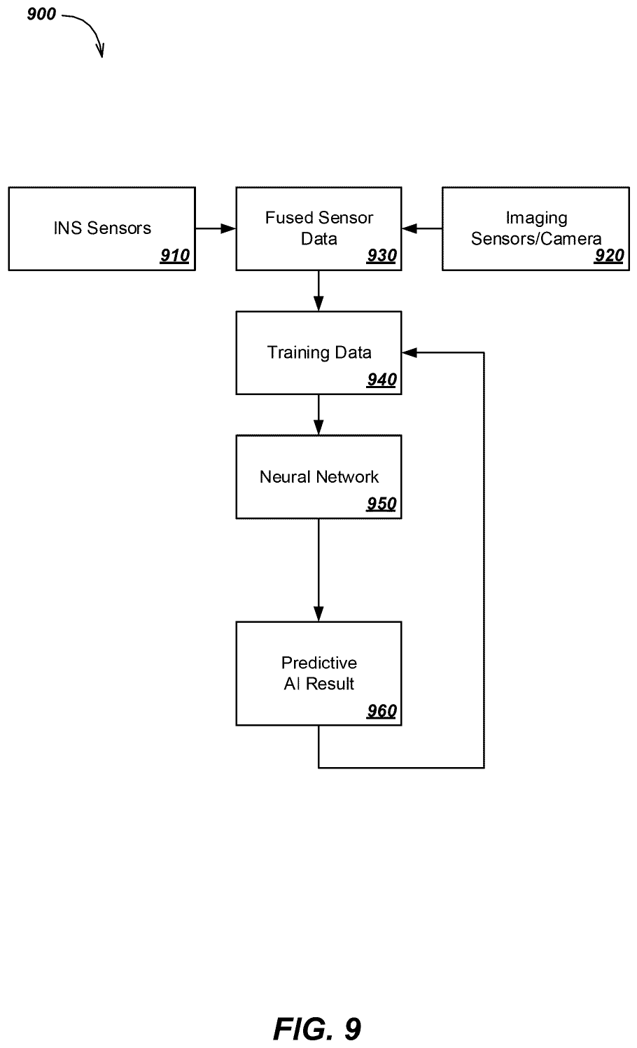

FIG. 9 illustrates details of an exemplary method 900 of using Fused Sensor Data as training data to a Neural Network to use Deep Learning/artificial intelligence to recognize patterns and make predictions related to underground utilities. Collected data from INS Sensors block 910 and Imaging Sensors/Camera(s) block 920 are combined as Fused Sensor data block 930, and used as Training Data block 940 to one or more Neural Networks block 950 to create a model. A predictive AI result block 960 based on the model is then used to provide a probability that pipes and/or conduits have specific characteristics, have relationships between other pipes and/or conduits, and fall into one or more classification or categories by using the training data to recognize patterns. Optionally, the Predictive AI result from block 960 may then be used as Training Data block 940.

The scope of the invention is not intended to be limited to the aspects shown herein but are to be accorded the full scope consistent with the disclosures herein and their equivalents, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use embodiments of the present invention. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the disclosures herein and in the appended drawings.

We claim:

1. A system for determining and distinguishing buried pipe characteristics using Artificial Intelligence (AI) comprising:
an imaging element for collecting image data;
one or more Inertial Navigation System (INS) sensors for collecting camera head position data;
an input element for allowing a user to input one or more predefined classifiers;
a processor for combining at least a portion of the collected image data and the collected INS sensor data (“collected data”) with at least one predefined classifier, wherein the processor outputs training data;
at least one Neural Network for processing the training data using Deep Learning performed by Artificial Intelligence (AI), and classifying the collected data based on a pipe characteristic predicted probability; and
an output element for presenting the classification data to a user.

2. The system of claim 1, wherein the pipe characteristic predicted probability includes at least one of a pipe type, pipe material, pipe size, pipe shape, pipe routing features, pipe connections, and pipe fitting characteristics.

3. The system of claim 2, wherein pipe fitting characteristics include at least one of male threaded, female threaded, welded, seamless, or overlapping.

4. The system of claim 2, wherein pipe type includes at least one of pipe manufacturer and pipe supplier.

5. The system of claim 2, wherein pipe material includes at least one of plastic, cast iron, and terracotta.

6. The system of claim 2, wherein pipe size includes at least one of an internal diameter, external diameter, wall thickness, and length.

7. The system of claim 2, wherein pipe shape includes at least one of circular, and non-circular.

8. The system of claim 2, wherein pipe fitting characteristics include at least one of a pipe-up fitting, and a pipe-down fitting.

9. The system of claim 1, wherein the imaging element comprises one or more of a camera or an imaging sensor.

10. The system of claim 1, wherein training data further includes mapping data.

11. The system of claim 10, wherein mapping data includes at least one of depth or orientation data.

12. The system of claim 1, wherein training data further includes fiber optic data.

13. The system of claim 1, further comprising a Sonde.

14. The system of claim 13, wherein training data further includes Sonde data.

15. The system of claim 1, further comprising additional sensors comprising at least one of an environmental sensor or an accelerometer.

16. The system of claim 15, wherein training data further includes data obtained from one or more of the additional sensors.

17. The system of claim 1, further comprising a microphone for recording voice annotation data.

18. The system of claim 17, wherein training data further comprises the voice annotation data.

19. The system of claim 1, wherein training data further includes other data.

20. The system of claim 19, wherein other data comprises one or more of observed data, user classification data, and ground truth data.

21. The system of claim 20, wherein ground truth data comprises one or more of ownership data, manufacturer data, connection data, utility box or junction data, and obstacle data.

22. The system of claim 1, wherein training data may be processed and classified in real time, or stored and post-processed in the Cloud.

23. The system of claim 1, wherein the output element comprises one or more of a visual display, a speaker or other sound producing element, and a vibration or other tactile producing element.

24. A method for determining and distinguishing buried pipe characteristics using Artificial Intelligence (AI) comprising:
collecting image data from an imaging element;
collecting camera head position data from one or more Inertial Navigation System (INS) sensors;
combining at least a portion of the collected image data and the collected INS sensor data (“collected data”) alone or in combination with at least one predefined classifier to generate training data;
providing the training data to at least one Neural Network;
using at least one Neural Network for processing the training data using Deep Learning performed by Artificial Intelligence (AI) and classifying the collected data based on a a pipe characteristic predicted probability; and
organizing and presenting the classified data to a user.

25. The method of claim 24, wherein the pipe characteristic predicted probability includes at least one of a pipe type, pipe material, pipe size, pipe shape, pipe routing features, pipe connections, and pipe fitting characteristics.

26. The method of claim 25, wherein pipe fitting characteristics include at least one of male threaded, female threaded, welded, seamless, or overlapping.

27. The method of claim 25, wherein pipe type includes at least one of pipe manufacturer and pipe supplier.

28. The method of claim 25, wherein pipe material includes at least one of plastic, cast iron, and terracotta.

29. The method of claim 25, wherein pipe size includes at least one of an internal diameter, external diameter, wall thickness, and length.

30. The method of claim 25, wherein pipe shape includes at least one of circular, and non-circular.

31. The method of claim 25, wherein pipe fitting characteristics include at least one of a pipe-up fitting, and a pipe-down fitting.

32. The method of claim 24, wherein the imaging element comprises one or more of a camera or an imaging sensor.

33. The method of claim 24, wherein training data further includes mapping data.

34. The method of claim 33, wherein mapping data includes at least one of depth or orientation data.

35. The method of claim 24, wherein training data further includes fiber optic data.

36. The method of claim 24, further comprising a Sonde.

37. The method of claim 36, wherein training data further includes Sonde data.

38. The method of claim 24, further comprising additional sensors comprising at least one of an environmental sensor or an accelerometer.

39. The method of claim 38, wherein training data further includes data obtained from one or more of the additional sensors.

40. The method of claim 24, further comprising a microphone for recording voice annotation data.

41. The method of claim 40, wherein training data further comprises the voice annotation data.

42. The method of claim 24, wherein training data further includes other data.

43. The method of claim 42, wherein other data comprises one or more of observed data, user classification data, and ground truth data.

44. The method of claim 43, wherein ground truth data comprises one or more of ownership data, manufacturer data, connection data, utility box or junction data, and obstacle data.

45. The method of claim 24, wherein training data may be processed and classified in real time, or stored and post-processed in the Cloud.

46. The method of claim 24, wherein the output element comprises one or more of a visual display, a speaker or other sound producing element, and a vibration or other tactile producing element.

47. The method of claim 24, wherein the one or more Inertial Navigation System (INS) sensors are located in, or attached to a CCU (Camera Control Unit).

48. The method of claim 24, wherein the one or more Inertial Navigation System (INS) sensors are located in, or attached to a utility locator.

49. The method of claim 24, wherein the one or more Inertial Navigation System (INS) sensors are located in, or attached to the camera head.

50. The method of claim 24, wherein the CCU is connected to a distal end of a push-cable, the camera head is connected to a proximal end of the push-cable, and the INS sensors communicate data from the camera head to the CCU via the push-cable.

51. A method for determining and distinguishing buried pipe characteristics using Artificial Intelligence (AI) comprising:
collecting image data from an imaging element;
collecting camera head position data from one or more Inertial Navigation System (INS) sensors;
fusing the collected image data with the collected camera head position data to generate a fused sensor data output;
generating training data using the fused sensor data alone or in combination with at least one predefined classifier;
providing the training data to at least one Neural Network;
using at least one Neural Network for processing the training data using Deep Learning performed by Artificial Intelligence (AI) and classifying the collected data based on a a pipe characteristic predicted probability; and
organizing and presenting the classified data to a user.

52. The method of claim 51, wherein the pipe characteristic predicted probability includes at least one of a pipe type, pipe material, pipe size, pipe shape, pipe routing features, pipe connections, and pipe fitting characteristics.

53. The method of claim 52, wherein pipe fitting characteristics include at least one of male threaded, female threaded, welded, seamless, or overlapping.

54. The method of claim 52, wherein pipe type includes at least one of pipe manufacturer and pipe supplier.

55. The method of claim 52, wherein pipe material includes at least one of plastic, cast iron, and terracotta.

56. The method of claim 52, wherein pipe size includes at least one of an internal diameter, external diameter, wall thickness, and length.

57. The method of claim 52, wherein pipe shape includes at least one of circular, and non-circular.

58. The method of claim 52, wherein pipe fitting characteristics include at least one of a pipe-up fitting, and a pipe-down fitting.

59. The method of claim 52, wherein one or more of the INS sensors comprise at least one of a 3-axis accelerometer, 3-axis gyroscope, and/or a 3-axis magnetometer.
